(19) United States
(12) Patent Application Publication
(10) Pub. No.: US 2026/0027889 A1
(43) Pub. Date: Jan. 29, 2026

(54) COOLING ASSEMBLY FOR A VEHICLE

(71) Applicant: Polaris Industries Inc., Medina, MN (US)

(72) Inventors: Karl L. Hacken, Prescott, WI (US); Brent C. Eaton, Lindstrom, MN (US); Jared Reiman, White Bear Lake, MN (US); William R. Shaw, Blaine, MN (US)

(21) Appl. No.: 19/278,327

(22) Filed: Jul. 23, 2025

Related U.S. Application Data
(60) Provisional application No. 63/676,104, filed on Jul. 26, 2024.

(51) Int. Cl. B60K 11/04; B60K 11/08; B60K 13/02; B62D 25/06; B62D 35/00

(52) U.S. Cl. CPC B60K 11/04; B60K 11/08; B60K 13/02; B62D 25/06; B62D 35/007

(57) ABSTRACT

A vehicle is provided comprising a plurality of ground engaging members, a frame extending along a vehicle centerline and supported by the plurality of ground engaging members, and a powertrain supported by the frame. A cooling assembly is operably coupled to the powertrain, the cooling assembly defining a radiator. A roof is supported by the frame, the roof defining a cavity, an inlet fluidly coupled to the cavity, and an outlet fluidly coupled to the cavity. Further, a fluid airpath is defined between the inlet and the outlet, and the roof outlet is operable to direct the fluid airpath toward the radiator.

### PRIORITY APPLICATIONS

This application claims the benefit of priority to U.S. Provisional Application Ser. No. 63/676,104, filed Jul. 26, 2024, the content of which is incorporated by reference in its entirety.

### FIELD OF THE DISCLOSURE

The present disclosure relates to a cooling assembly for a utility vehicle.

### BACKGROUND OF THE DISCLOSURE

Utility and recreational vehicles may operate at low speeds and high speeds which may produce high cooling loads within the powertrain. Cooling assemblies for managing cooling loads on the utility vehicle are disclosed herein.

### SUMMARY OF THE DISCLOSURE

In an embodiment of the present disclosure, a vehicle is provided. The vehicle comprises a plurality of ground engaging members, a frame extending along a vehicle centerline and supported by the plurality of ground engaging members. A powertrain is supported by the frame and a cooling assembly is operably coupled to the powertrain, the cooling assembly defining a radiator. A roof is supported by the frame, the roof defining a cavity, an inlet fluidly coupled to the cavity, and an outlet fluidly coupled to the cavity. A fluid airpath is defined between the inlet and the outlet, and the roof outlet is operable to direct the fluid airpath toward the radiator.

In embodiments, the frame surrounds an operator area and the radiator is positioned rearwardly of the operator area.

In embodiments, the radiator is positioned vertically within an envelope defined by the frame.

In embodiments, the roof defines a first portion and a second portion, and the first portion is coupled to the second portion, and the cavity is defined between the first portion and the second portion.

In embodiments, the first portion defines an aperture, and the second portion extends through the aperture.

In embodiments, at least one vertically extending support extends between the first portion and the second portion.

In embodiments, the cooling assembly includes a shroud positioned adjacent the radiator, and the fluid airpath is directed towards the shroud.

In embodiments, a cover is coupled to the shroud, and the cover defines a cover inlet positioned along the vehicle centerline.

In embodiments, a cover is coupled between the roof and the shroud.

In embodiments, the powertrain includes an air intake assembly including an air inlet, and the air inlet is positioned longitudinally aligned with the cover inlet.

In embodiments, the powertrain further comprises a charger and an intercooler fluidly coupled to the charger, the shroud defining a recess and the intercooler positioned within the recess.

In embodiments, the cooling assembly includes a bracket coupled to the radiator and a coolant bottle coupled to the bracket, the coolant bottle defining a coolant aperture and the bracket defining a bracket aperture, and a conduit coupled between the coolant aperture and the bracket.

In yet another embodiment of the present disclosure, a roof for a utility vehicle is provided. The roof comprising a first portion and a second portion coupled to the first portion. The first portion and the second portion define an inlet, an outlet spaced from the inlet, and a cavity positioned between the inlet and the outlet, the cavity having a generally consistent cross-sectional area along the longitudinal length of the cavity.

In embodiments, the first portion defines an aperture and the second portion extends through the aperture.

In embodiments, the first portion defines a rearward extent and a wing portion along the rearward extent, the wing portion extending generally upwardly and rearwardly from the first portion.

In embodiments, at least one vertically extending support is coupled between the first portion and the second portion.

In yet another embodiment of the present disclosure, a cooling assembly for a vehicle including a frame supported by a plurality of ground engaging members, and a powertrain coupled to the plurality of ground engaging members is provided. The cooling assembly comprising a radiator supported by the frame and an intercooler longitudinally spaced form the radiator. A transmission cooler is coupled to a transmission of the powertrain and a plurality of conduits fluidly coupling the radiator, intercooler, and transmission.

In embodiments, a pump is positioned fluidly intermediate the radiator and the intercooler.

In embodiments, the transmission cooler is longitudinally spaced from the radiator.

In embodiments, the transmission cooler is positioned vertically lower than the intercooler.

In yet another embodiment, a vehicle is provided. The vehicle comprises a plurality of ground engaging members, a frame supported by the plurality of ground engaging members, and the frame includes a lower frame portion and an upper frame portion. The upper frame portion comprising a first side frame portion and a second side frame portion and at least one cross-member extending between the first side frame portion and the second side frame portion. A powertrain is supported by the frame, the powertrain operably coupled to at least one of the plurality of ground engaging members, the powertrain including an air intake assembly comprising an air inlet. Further, the first side frame portion defines a lateral outer extent and a lateral inner extent, and the air inlet is positioned laterally intermediate the lateral outer extent and the lateral inner extent.

In yet another embodiment, a method of operating a cooling assembly of a vehicle is provided. The method comprising receiving a user input to turn the vehicle to an OFF-state, operating a fan of the cooling assembly for a predetermined amount of time after the vehicle is altered to the OFF-state, and wherein the predetermined amount of time is determined based upon one of a calibratable amount of time and a temperature of the powertrain of the vehicle.

In yet another embodiment, a powertrain for a vehicle is provided. The powertrain comprising a prime mover including an intake inlet and exhaust outlet. An air intake assembly is fluidly coupled to the intake inlet, the air intake assembly comprising an air inlet and an airbox fluidly coupled between the air inlet and the intake inlet. The airbox comprises an airbox inlet defining an inlet axis, an airbox outlet defining an outlet axis, and an angle is defined between the inlet axis and the outlet axis, the angle being less than 90 degrees.

In embodiments, a filter positioned within the airbox, the filter positioned fluidly intermediate the airbox inlet and the airbox outlet.

In embodiments, the airbox comprises a first portion coupled to the second portion, and the first portion defines the airbox inlet and the second portion defines the airbox outlet.

In embodiments, the angle is less than 45 degrees.

In embodiments, the air intake assembly includes a housing defining the air inlet, and the housing is positioned above the airbox.

In embodiments, the airbox defines a longitudinal centerline, and the airbox inlet and the airbox outlet are positioned on a first side of the longitudinal centerline.

### BRIEF DESCRIPTION OF THE DRAWINGS

FIG. 1 is a front left perspective view of a vehicle of the present disclosure;

FIG. 2 is a rear right perspective view of a vehicle of the present disclosure;

FIG. 3 is a left side view of a vehicle of the present disclosure;

FIG. 4 is a right side view of a vehicle of the present disclosure;

FIG. 5 is a top view of a vehicle of the present disclosure;

FIG. 6 is a front view of a vehicle of the present disclosure;

FIG. 7 is a rear view of a vehicle of the present disclosure;

FIG. 8 is a diagram of a powertrain for a vehicle of the present disclosure;

FIG. 9 is a front left perspective view of an upper frame and roof of a vehicle of the present disclosure;

FIG. 10 is an exploded view of the roof of FIG. 9;

FIG. 11 is a bottom perspective view of the roof of FIG. 9;

FIG. 12 is a cross-sectional view of the roof of FIG. 9 taken along line 12-12 in FIG. 9;

FIG. 13 is a cross-sectional view of the roof of FIG. 9 taken along line 12-12 in FIG. 9 shown relative to a cooling assembly of a vehicle of the present disclosure;

FIG. 14 is a cross-sectional view of the roof of FIG. 9 taken along line 12-12 in FIG. 9 shown relative to a windshield, a cover member, and a portion of a cooling assembly of a vehicle of the present disclosure;

FIG. 15 is a bottom perspective view of a roof and a portion of a cooling assembly for a vehicle of the present disclosure;

FIG. 16 is an exploded view of a portion of a cooling assembly for a vehicle of the present disclosure;

FIG. 17 is a left side view of a portion of a cooling assembly for a vehicle of the present disclosure;

FIG. 18 is a right side view of a portion of a cooling assembly for a vehicle of the present disclosure;

FIG. 19 is a front view of a portion of a cooling assembly for a vehicle of the present disclosure;

FIG. 20 is a cross-sectional view of a rear portion of a vehicle of the present disclosure showing a portion of a cooling assembly of the vehicle;

FIG. 21 is an exploded view of a rear portion of a vehicle showing a portion of a cargo assembly, an intake assembly, and a portion of a cooling assembly of the present disclosure;

FIG. 22 is a top view of a rear portion of a vehicle showing a portion of a cargo assembly, an intake assembly, and a portion of a cooling assembly of the present disclosure;

FIG. 23 is a rear view of a rear portion of a vehicle showing a portion of a cargo assembly, an intake assembly, and a portion of a cooling assembly of the present disclosure;

FIG. 24 is a left view of a portion of a vehicle of the present disclosure;

FIG. 25 is a right view of a portion of a vehicle of the present disclosure;

FIG. 26 is a top view of a portion of a vehicle of the present disclosure;

FIG. 27 is a rear view of a portion of a vehicle of the present disclosure;

FIG. 28 is a control diagram for operating a cooling system of a vehicle of the present disclosure;

FIG. 29 is a perspective view of an engine intake assembly of a vehicle of the present disclosure;

FIG. 30 is an exploded view of an engine intake assembly of a vehicle of the present disclosure;

FIG. 31 is a cross-section view of an airbox of an engine intake assembly of a vehicle of the present disclosure taken along line 31-31 of FIG. 29;

FIG. 32 is a perspective view of an air intake assembly of a vehicle of the present disclosure;

FIG. 33 is a perspective view of an air intake assembly of a vehicle of the present disclosure;

FIG. 34 is an exploded view of an air intake assembly of a vehicle of the present disclosure;

FIG. 35 is a top view of a rear of a vehicle showing an air intake assembly of the vehicle of the present disclosure;

FIG. 36 is a cross-sectional view of an airbox of an air intake assembly of a vehicle of the present disclosure;

FIG. 37 is a diagram of a cooling assembly of a vehicle of the present disclosure;

FIG. 38 is a perspective view of a cooling assembly of a vehicle of the present disclosure;

FIG. 39 is a perspective view of a coolant bottle of a cooling assembly of a vehicle of the present disclosure; and

FIG. 40 is an exploded view of a coolant bottle of a cooling assembly of a vehicle of the present disclosure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

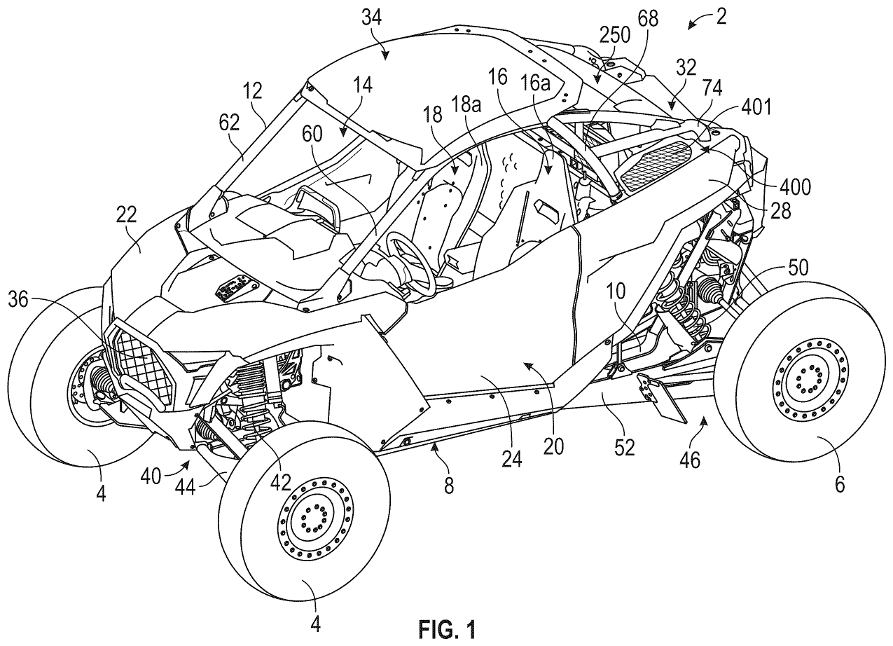

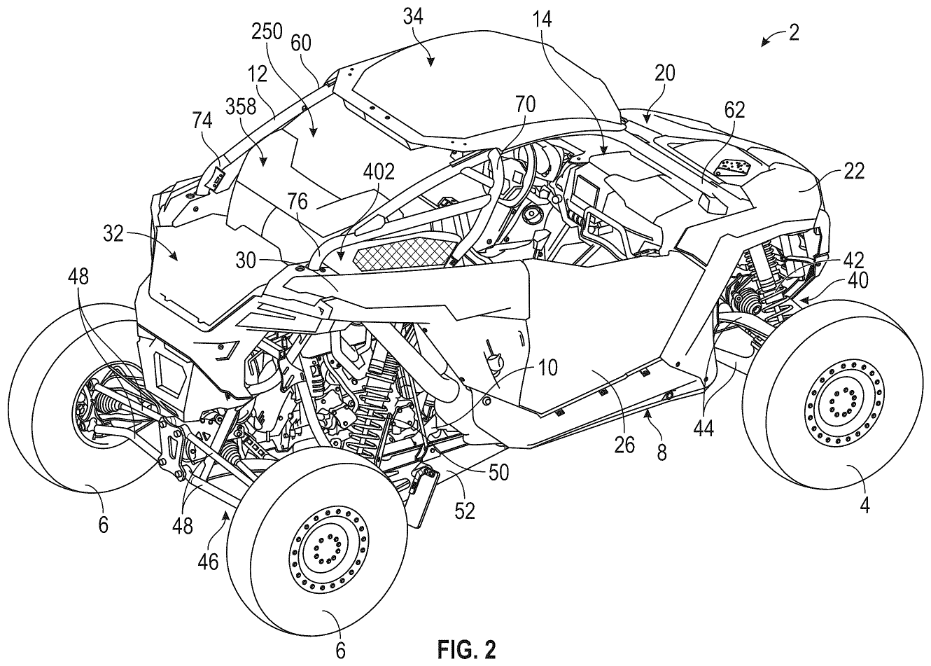

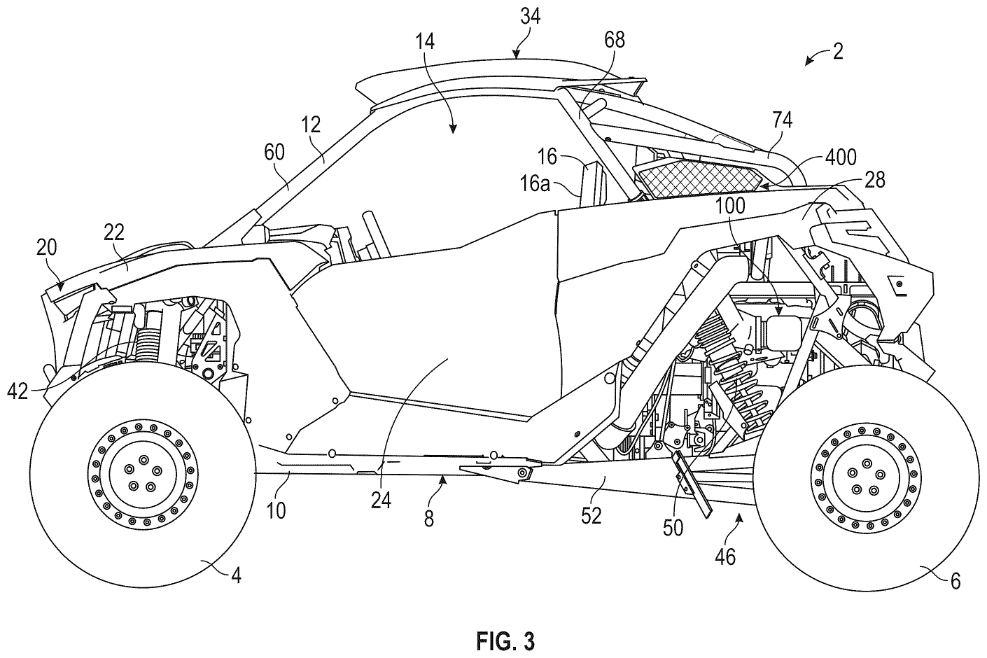

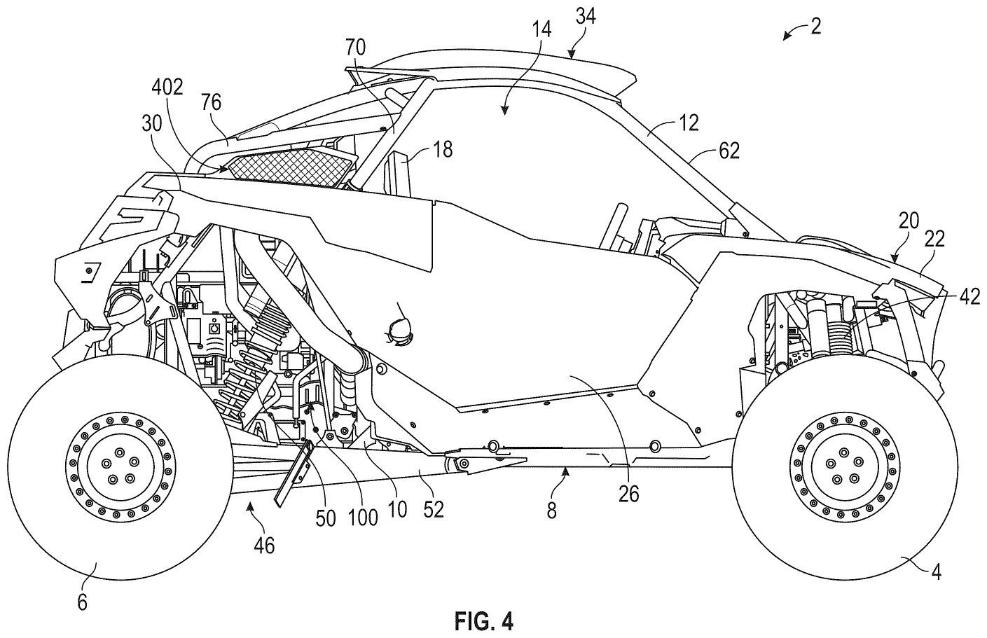

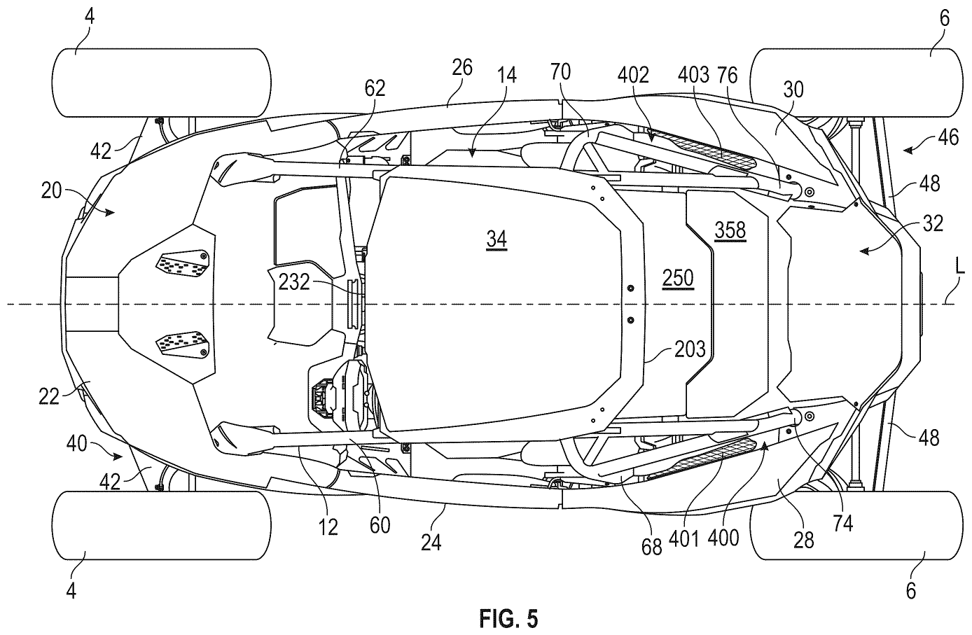

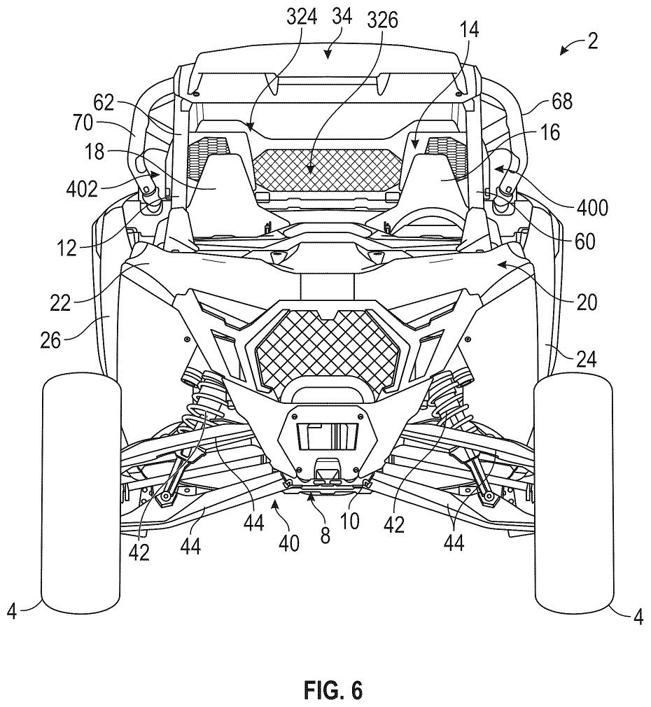

Referring to FIGS. 1-7, a vehicle 2 includes a plurality of ground engaging members 4, 6, including a pair of front ground engaging members 4 and a pair of rear ground engaging members 6. In embodiments, ground engaging members 4, 6 are wheels with tires. In embodiments, one or more of ground engaging members 4, 6 are tracks, skis, or other ground engaging members. Vehicle 2 includes a frame 8 supported by the plurality of ground engaging members 4, 6. Frame 8 extends along a vehicle centerline L, and frame 8 includes a lower frame portion, or chassis 10 and an upper frame portion 12 coupled to the chassis 10. Frame 8 defines an operator area 14 positioned generally intermediate the lower frame portion 10 and the upper frame portion 12. A pair of seats 16, 18 are positioned within the operator area 14. Seat 16 is a driver seat 16 including a seatback 16a and a seat bottom (not shown) and seat 18 is a passenger seat 18 including a seatback 18a and a seat bottom (not shown).

Referring still to FIGS. 1-7, a body assembly 20 is supported by frame 8. Body assembly 20 includes a hood 22, a driver-side door 24, a passenger-side door 26, a driver-side fender 28, a passenger-side fender 30, and a cargo box 32. In embodiments, vehicle 2 includes a roof 34 supported by the upper frame portion 12. Vehicle 2 may also include a grille 36 positioned adjacent a front of vehicle 2 generally below the hood 22.

Referring still to FIGS. 1-7, vehicle 2 includes a front suspension 40 coupled between chassis 10 and front ground engaging members 4. Front suspension 40 may be an A-arm suspension including a pair of front shock absorbers 42 extending between one or more control arms 44 and chassis 10. In embodiments, front suspension 40 may be a strut suspension or another type of suspension. Vehicle 2 includes a rear suspension 46 coupled between chassis 10 and rear ground engaging members 6. Rear suspension may be an independent trailing arm suspension including one or more control arms 48 coupled between rear ground engaging members 6 and chassis 10, a pair of trailing arms 52 coupled between rear ground engaging members 6 and chassis 10, and a pair of shock absorbers 50 coupled between trailing arms 52 and chassis 10. In embodiments, rear suspension 46 may be an A-arm type suspension, a strut suspension, a swingarm suspension, or another type of suspension.

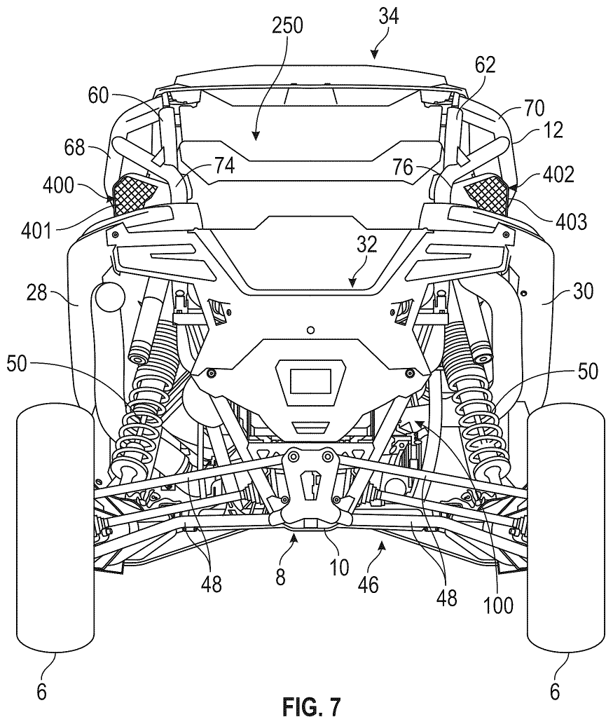

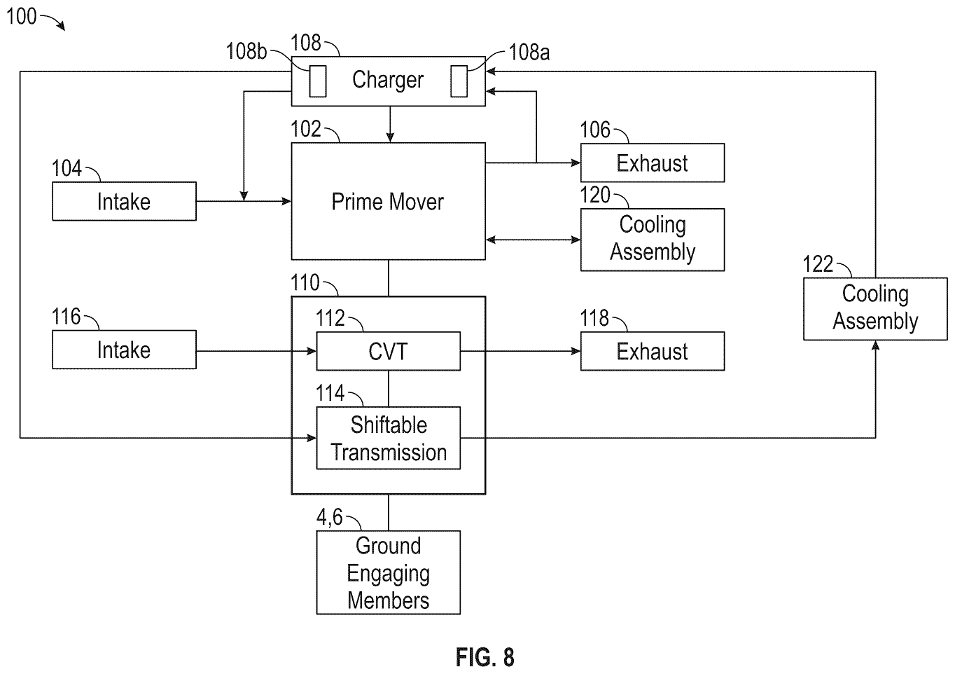

Referring to FIGS. 7-8, vehicle 2 includes a powertrain 100 supported by frame 8 and positioned generally rearwardly of operator area 14. Powertrain 100 may include a prime mover 102 which may include an internal combustion engine. In embodiments, prime mover 102 may be an electric motor or another type of prime mover. Powertrain 100 includes an engine intake assembly 104 fluidly coupled to prime mover 102 and an engine exhaust assembly 106 fluidly coupled to prime mover 102. Powertrain 100 may include a charger 108 (e.g., a turbocharger, a supercharger) operably coupled to prime mover 102. Charger 108 may be a turbocharger having a turbine 108a spun up by exhaust gasses from engine exhaust assembly 106, and the turbine may be rotatably coupled to a compressor to pressurize fresh air for the engine intake assembly 104 of prime mover 102. Powertrain 100 may also include a transmission assembly 110 operably coupled between prime mover 102 and at least one ground engaging member 4, 6. Transmission assembly 110 may include a continuously variable transmission (CVT) 112 and a shiftable transmission 114. CVT 112 may include a drive clutch (not shown) operably coupled to prime mover 102 and a driven clutch (not shown) rotatably coupled to the drive clutch by an endless belt. Shiftable transmission 114 may be operably coupled to the driven clutch of CVT 112. CVT 112 may be operable to infinitely adjust a gear ratio of powertrain 100. Shiftable transmission 114 may be shiftable between a plurality of discrete gears (e.g., high, low, reverse, park, neutral). In embodiments, shiftable transmission 114 may be shiftable between a plurality of discrete forward gears and a plurality of reverse gears. In embodiments, shiftable transmission 114 may be operably coupled to one or more of the plurality of ground engaging members 4, 6 by one or more of drive shafts and differentials. Powertrain 100 may also include a transmission intake assembly 116 fluidly coupled to CVT 112 and a transmission exhaust assembly 118 fluidly coupled to CVT 112. In embodiments, transmission assembly 110 may be operable to power one of ground engaging members 4, 6 (e.g., 1×4), two ground engaging members 4, 6 (e.g., 2×4), three ground engaging members 4, 6 (e.g., 3×4), and four ground engaging members 4, 6 (e.g., 4×4).

Referring now to FIG. 8, powertrain 100 includes a cooling assembly 120 operably coupled to prime mover 102. Powertrain 100 may also include a cooling assembly 122 operably coupled to each of charger 108 and shiftable transmission 114. Vehicle 2 may also include an electronic controller 90 operably coupled to one or more of the prime mover 102, cooling assembly 120, and cooling assembly 122. Electronic controller 90 may include a memory and a processor to implement instructions to control one or more of the prime mover 102, cooling assembly 120, and cooling assembly 122.

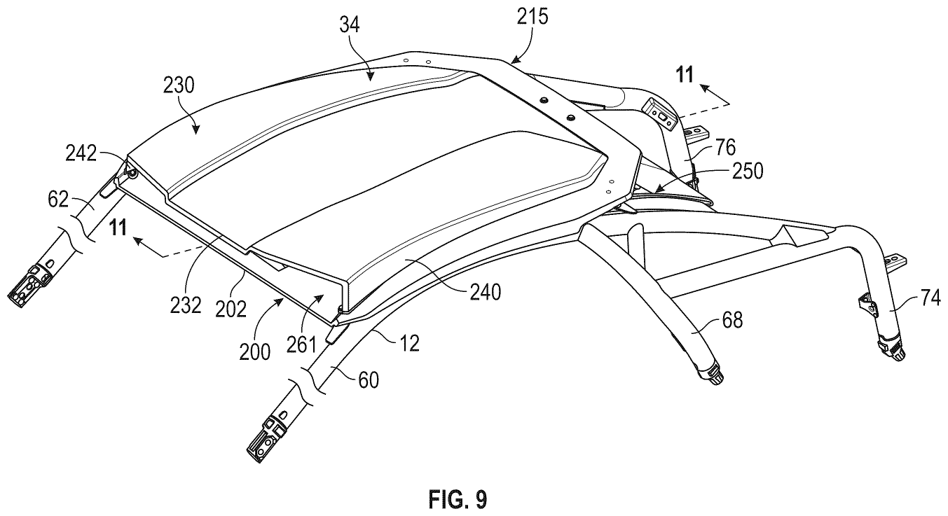

Referring to FIG. 9, upper frame portion 12 includes a first frame member 60 extending generally longitudinally and a second frame member 62 extending generally longitudinally and laterally offset from the first frame member 60. A third frame member 68 extends downwardly from first frame member 60 and a fourth frame member 70 extends downwardly from the second frame member 62. Further, a fifth frame member 74 extends downwardly from the first frame member 60 rearwardly of the third frame member 68 and a sixth frame member 76 extends downwardly from the second frame member 62 rearwardly of the fourth frame member 70.

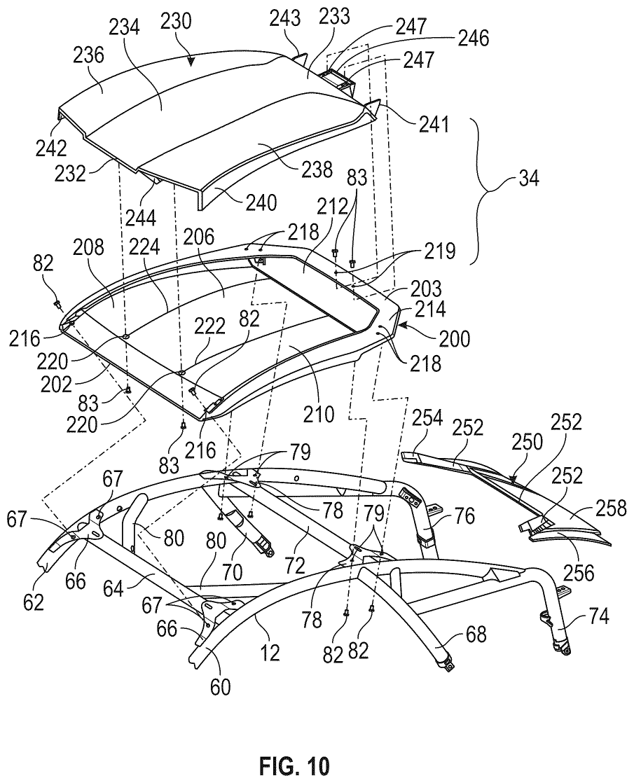

With reference to FIG. 10, a first cross-member 64 extends between first frame member 60 and second frame member 62 at a position generally forwardly of each of third frame member 68 and fourth frame member 70 and a second cross-member 72 extends between first frame member 60 and second frame member at a position generally aligned with third frame member 68 and fourth frame member 70. Upper frame portion 12 may include a pair of supports 80 coupled between first cross-member 64 and each of first frame member 60 and second frame member 62. Further, upper frame portion 12 may include one or more brackets 66 coupled between each of first frame member 60, second frame member 62 and first cross-member 64 and one or more brackets 78 coupled between each of first frame member 60, second frame member 62 and second cross-member 72. Brackets 66 and brackets 78 may provide additional support to upper frame portion 12. Brackets 66 may define a plurality of apertures 67 and brackets 78 define a plurality of apertures 79.

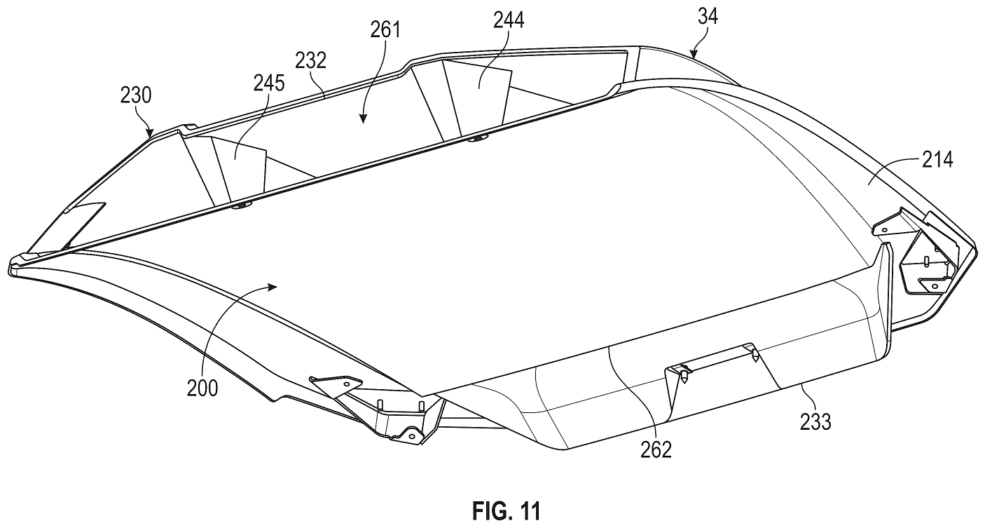

Referring now to FIGS. 9-13, roof 34 includes a first portion or lower portion 200 and a second portion or upper portion 230. Lower portion 200 includes a leading edge or forward edge 202 and a rearward edge 203. Lower portion 200 defines a front lip 204 adjacent the leading edge 202. Lower portion 200 also includes a main body portion or first portion 206, a right-side portion or second portion 208, a left-side portion or third portion 210, and a rim portion 214 extending around each of first portion 206, second portion 208, and third portion 210. Lower portion 200 defines an aperture 212 between each of first portion 206, second portion 208, third portion 210 and rim portion 214. Aperture 212 generally defines an outlet 262 of roof 34. Lower portion 200 includes a fourth portion 222 positioned intermediate the first portion 206 and the third portion 210 and a fifth portion 224 positioned intermediate the first portion 206 and the second portion 208. In embodiments, one or more of fourth portion 222 and fifth portion 224 may be more structurally rigid (e.g., thicker, stronger material) than either of first portion 206, second portion 208, and third portion 210.

Referring to FIG. 10, each of fourth portion 222 and fifth portion 224 define a pair of apertures 220. Front lip 204 defines a plurality of apertures 216 spaced on either lateral end of front lip 204. Rim portion 214 defines a plurality of apertures 218 generally positioned toward a rearward portion of first portion 200 and a pair of apertures 219 positioned at a rearward portion of first portion 200 along rim portion 214.

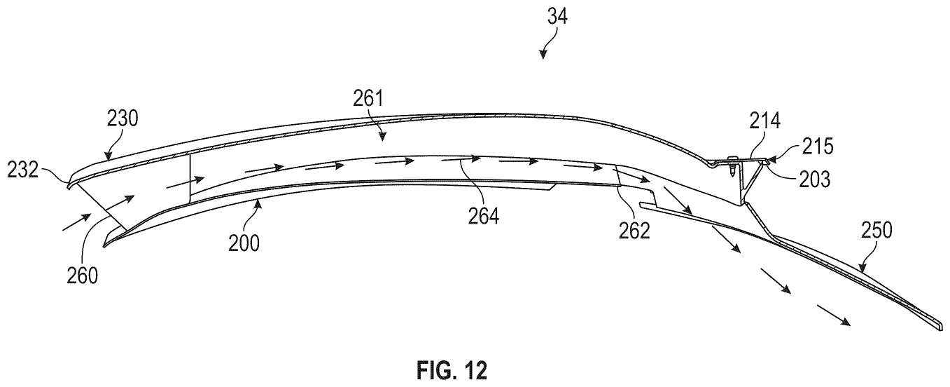

Referring to FIGS. 12-14, lower portion 200 of roof 34 defines a wing portion 215 at a rearward extent 203 of lower portion 200. Wing portion 215 projects generally upwardly and rearwardly to increase the aerodynamics of roof 34 and vehicle 2.

Referring still to FIG. 10, second portion 230 of roof 34 includes a leading edge or forward edge 232, a rear extent 233 spaced from forward edge 232, a first portion 234, a second portion 236 laterally offset from the first portion 234, and a third portion 238 laterally offset from each of the first portion 234 and second portion 236. Second portion 230 of roof 34 includes a first edge 240 extending downwardly from and positioned adjacent to the third portion 238 and a second edge 242 extending downwardly from, and positioned adjacent to the second portion 236. That is, first edge 240 and second edge 242 generally define lateral bounds of second portion 230. Second portion 230 defines a first projection 244 extending downwardly from a bottom surface of third portion 238 and a second projection 245 extending downwardly from a bottom surface of second portion 236. Second portion 230 further defines a pair of rear projections 241, 243 laterally spaced from each other along rear extent 233, and a center projection 246 positioned intermediate the rear projections 241, 243 along rear extent 233. Center projection 246 defines a pair of apertures 247. In embodiments, first projection 244 and second projection 246 are support members and may extend upwardly from first portion 200 of roof 34. In embodiments, first projection 244 and second projection 246 are separate components and are coupled to each of first portion 200 and second portion 230 of roof 34. In embodiments, first projection 244 and second projection 245 are generally vertically extending supports.

In embodiments, roof 34 may be coupled to upper frame portion 12 by a plurality of fasteners. Fasteners may include screws, bolts, or other fasteners. That is, first portion 200 may be positioned onto upper frame portion 12 such that a first plurality of fasteners 82 extend through apertures 67 of brackets 66 and apertures 216 of first portion 200 and fasteners 82 extend through apertures 79 of brackets 78 and apertures 218 of first portion 200 to couple first portion 200 to upper frame portion 12.

Referring still to FIG. 10, rear extent 233 of second portion 230 can extend through aperture 212 such that rear extent 233 is positioned below rim portion 214 of first portion 200. Further, second portion 230 may be coupled to first portion 200 by a plurality of fasteners. Fasteners may include screws, bolts, or other fasteners. That is, second portion 230 may be positioned on top of first portion 200 such that first projection 244 is positioned vertically above fourth portion 222 and second projection 245 is positioned vertically above fifth portion 224 and a plurality of fasteners 83 may extend through apertures 220 of first portion and a pair of apertures (not shown) in each of first projection 244 and second projection 245 and a plurality of fasteners 83 may extend through apertures 219 of rim portion 214 and apertures 247 of second portion 230.

Referring now to FIGS. 9-12, first portion 200 and second portion 230 of roof 34 define an air inlet 260 and the air outlet 262 and a cavity 261 therebetween. Air inlet 260 has a predetermined cross-sectional area and cavity 261 generally maintains the predetermined cross-sectional area throughout the longitudinal length of cavity 261. In embodiments, air outlet 262 has approximately the same cross-sectional area as the air inlet 260. In embodiments, air outlet 262 has a smaller cross-sectional area than air inlet 260. Thus, the cross-sectional area of cavity 261 may maintain a minimum cross-sectional area or may otherwise vary across its longitudinal length in other examples. In embodiments, cavity 261 generally maintains a cross-sectional area of plus-or-minus 5% of the predetermined cross-sectional area.

Referring to FIG. 10, a rear panel 250 is positioned generally rearwardly of roof 34 and includes a main body 258 and a pair of extensions 254, 256 extending upwardly from the main body 258. A flange 252 angles upwardly from a forward edge of each of extensions 254, 256, and main body 258. In embodiments, rear panel 250 is coupled to each of first frame member 60 and second frame member 62. In embodiments, rear panel 250 is coupled to roof 34. In embodiments, rear panel 250 is coupled to each of first frame member 60 and second frame member 62 and roof 34. Rear panel 250 is coupled to roof 34 such that a generally continuous surface is created between rear panel 250 and roof 34.

Referring now to FIG. 12, roof 34 defines an air flow path 264 through air inlet 260, cavity 261, and air outlet 262. In embodiments, air flows through air inlet 260, through cavity 261, and generally angled downwardly out of air outlet 262 and downwardly along rear panel 250.

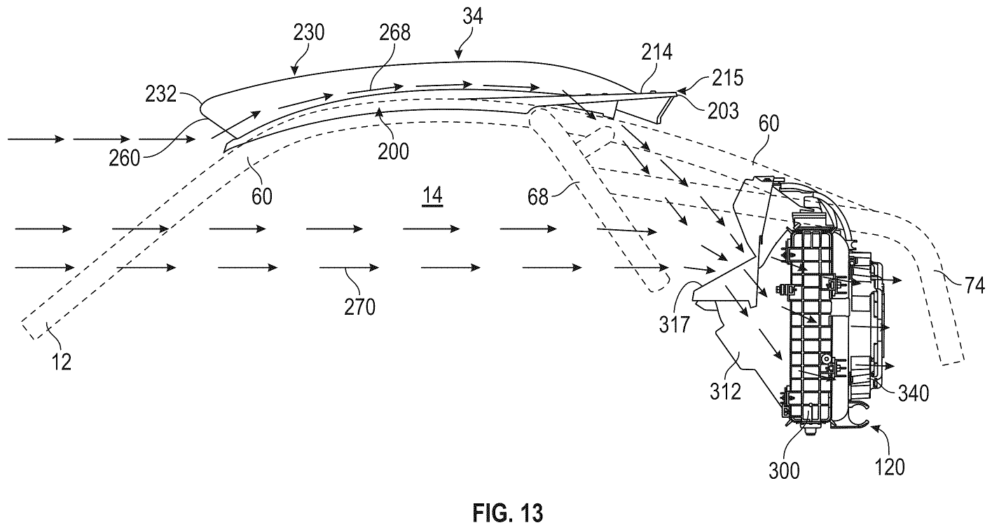

Referring to FIG. 13, vehicle 2 may include a first configuration with cooling assembly 120 positioned rearwardly and downwardly from roof 34. Cooling assembly 120 may be positioned generally rearward of third frame member 68. Cooling assembly 120 may be positioned generally forwardly of at least a portion of fifth frame member 74. In the first configuration, rear panel 250 may be included. In the first configuration, rear panel 250 may not be included.

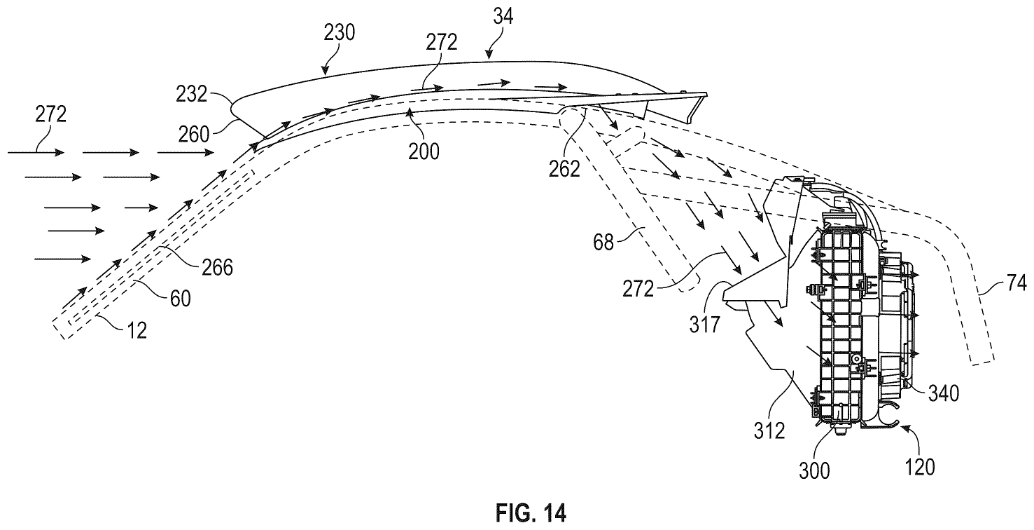

Referring to FIG. 14, vehicle 2 may include a second configuration including a windshield 266. Windshield 266 may extend between first frame member 60 and second frame member 62 and generally cover, from a front perspective, the operator area 14. Cooling assembly 120 may be positioned generally rearward of third frame member 68. Cooling assembly 120 may be positioned generally forwardly of at least a portion of fifth frame member 74. Cooling assembly 120 may be positioned rearwardly of windshield 266. In embodiments, cooling assembly 120 may be at least partially laterally aligned with windshield 266. In the second configuration, rear panel 250 may be included. In the second configuration, rear panel 250 may not be included.

Referring still to FIGS. 12-14, air path 264 may include a plurality of air paths based upon the vehicle having the first configuration or the second configuration. As shown in FIG. 12, in the first configuration, air path 264 may include a first air path 268 through the roof 34 and pointing generally downwardly toward cooling assembly 120 and a second air path 270 through operator area 14 toward cooling assembly 120. As shown in FIG. 13, in the second configuration, air path 264 may include a third air path 272 which contacts the windshield 266 and flows upwardly into the inlet 260 of roof 34, through roof 34, and downwardly through outlet 262, and downwardly along rear panel 250 toward cooling assembly 120.

In embodiments, rear panel 250 is a diverter member to direct air coming out of outlet 262 of roof 34 toward cooling assembly 120. Rear panel 250 may be omitted in the first configuration (e.g., without a windshield 266) because second air path 270 goes through operator area 14 toward cooling assembly 120. Rear panel 250 may offer improved cooling in the second configuration (e.g., with a windshield 266) because cooling assembly 120 may rely more on air from the third air path 272, and rear panel 250 may direct a greater portion of air coming out of roof 34 toward cooling assembly 120.

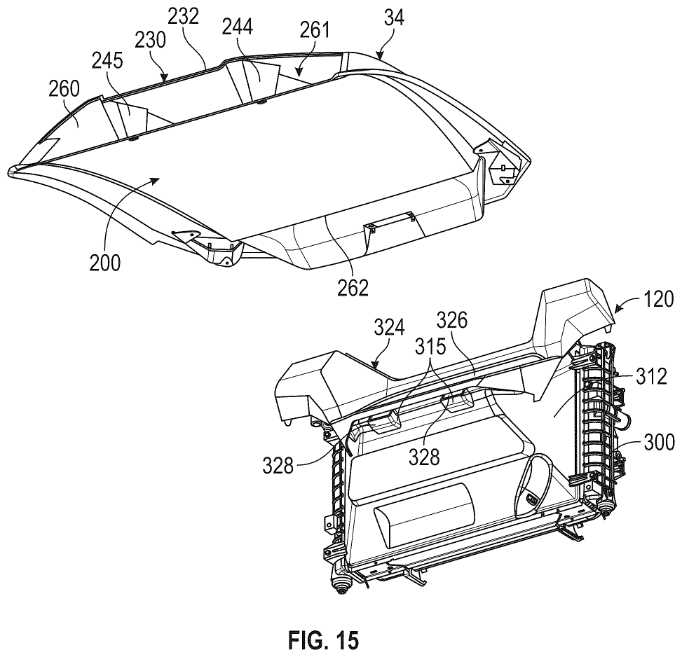

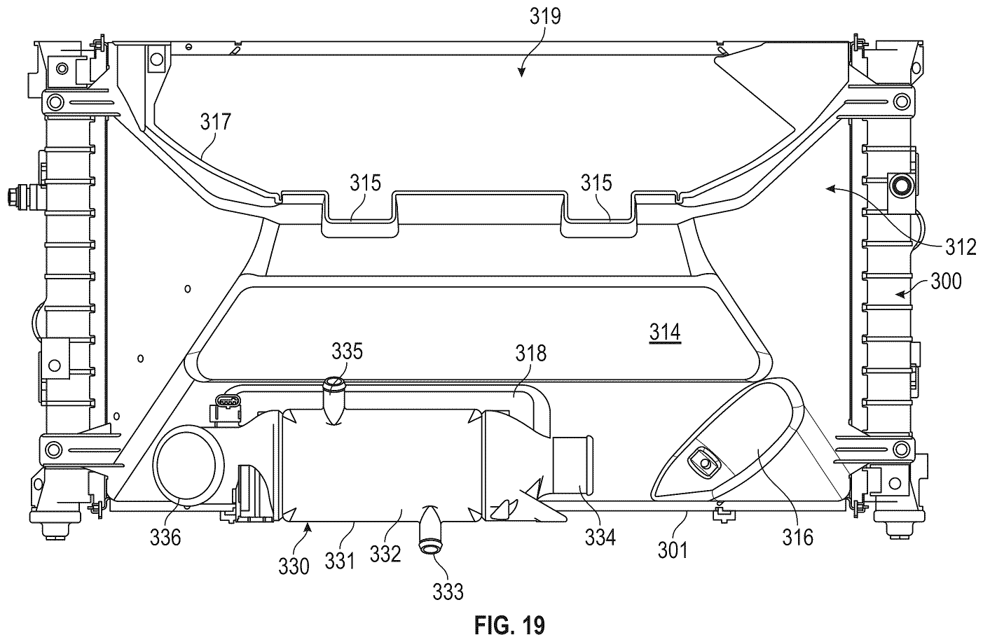

Referring now to FIGS. 15-19, a portion of cooling assembly 120 may include a radiator or exchanger 300, a shroud 312, and a fan 340. In embodiments, shroud 312 is coupled to a forward side of radiator 300 and fan 340 is coupled to a rearward side of radiator 300. A cover 324 is coupled to exchanger 300 and shroud 312 and cover 324 is facing generally upwardly.

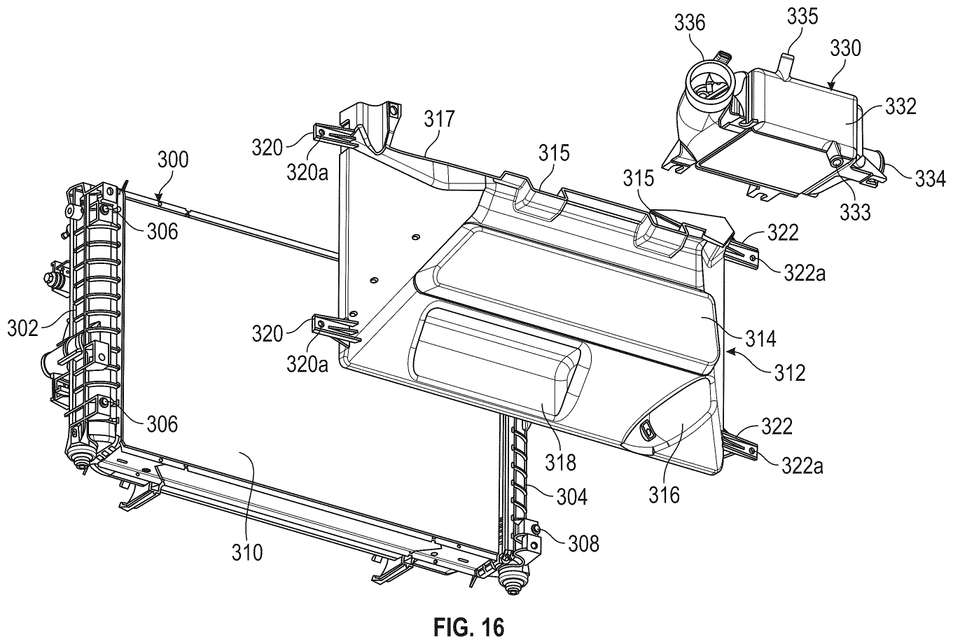

Referring to FIG. 16, radiator 300 includes a first lateral side or right side 302, a second lateral side or left side 304, a first pair of apertures 306 positioned on the first lateral side 302 and a second pair of apertures 308 positioned on the second lateral side 304. Radiator 300 further includes a face 310 facing generally forwardly. Further, shroud 312 includes a body 314 defining a first recess 316 and a second recess 318. Body 314 further includes a first pair of tabs 320 defining a first pair of apertures 320a and a second pair of tabs 322 defining a second pair of apertures 322a. Body 314 further defines an aperture 317 and a pair of recesses 315 positioned adjacent the aperture 317. Body 314 generally defines a cavity 319. Cover 324 is coupled to exchanger 300 and shroud 312 and cover 324 defines a grille 326 and a pair of extensions 328. Extensions 328 may sit within recesses 315 to couple cover 324 to shroud 312. In embodiments, fan 340 is coupled to a rearward side of radiator 300. Fan 340 is operable to pull air through radiator 300. In embodiments, fan 340 operates according to a duty cycle. Fan 340 may also include one or more clamps 342 to retain tubes or conduits (not shown). While the present example depicts an instance where fan 340 pulls air through radiator 300, it will be appreciated that similar aspects may be used in a configuration in which fan 340 pushes air through radiator 300 (or a combination thereof).

Referring still to FIG. 16, cooling assembly 122 includes an exchanger 330. In embodiments, exchanger 330 may be an intercooler such as a liquid-to-air charged air cooler. In embodiments, exchanger 330 includes a body 332, an inlet 334 and an outlet 336. Air may flow through air inlet, cooling a liquid fluid (e.g., coolant) and subsequently flow out of outlet. Exchanger 330 also includes a fluid inlet 335 and a fluid outlet 333. Coolant fluid may flow into fluid inlet 335, may flow through a plurality of conduits and exchange thermal energy with air flowing through exchanger 330 and the coolant fluid may subsequently flow out of fluid outlet 333.

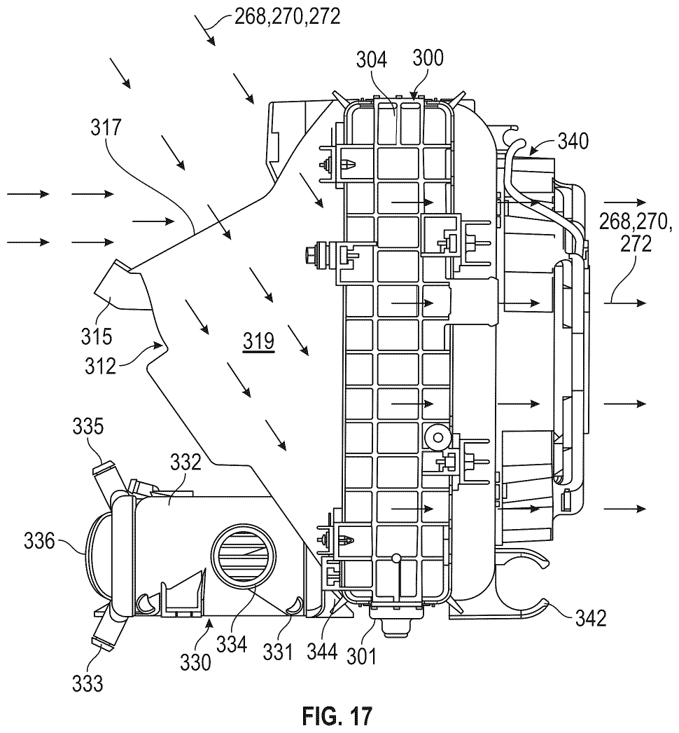

Referring again to FIGS. 17-19, intercooler 330 is positioned to sit within recess 318 of shroud 312. That is, intercooler 330 is positioned generally below shroud 312 and adjacent radiator 300 such that, from a side view, a portion of the intercooler 330 overlaps a portion of the shroud 312 and from a front view, a portion of the intercooler is laterally and vertically aligned with radiator 300 and shroud 312. Intercooler 330 may sit within recess 318 to reduce the overall packaging size of cooling assembly 120 and cooling assembly 122. Further, a bottom extent 331 of intercooler 330 may be positioned at a vertical height similar to that of a bottom extent 301 of radiator 300. In embodiments, a rearward extent 333 of intercooler 330 is longitudinally offset from face 310 and shroud 312 to provide an air-gap 344 between intercooler 330 and face 310, shroud 312.

Referring again to FIGS. 13-14, radiator 300, shroud 312, and fan 340 may be positioned completely below an upper extent of upper frame assembly 12. Further, radiator 300, shroud 312, and fan 340 may be positioned longitudinally intermediate third frame member 68 and fifth frame member 74. That is, radiator 300, shroud 312, and fan 340 may be positioned completely within an envelope of frame 8.

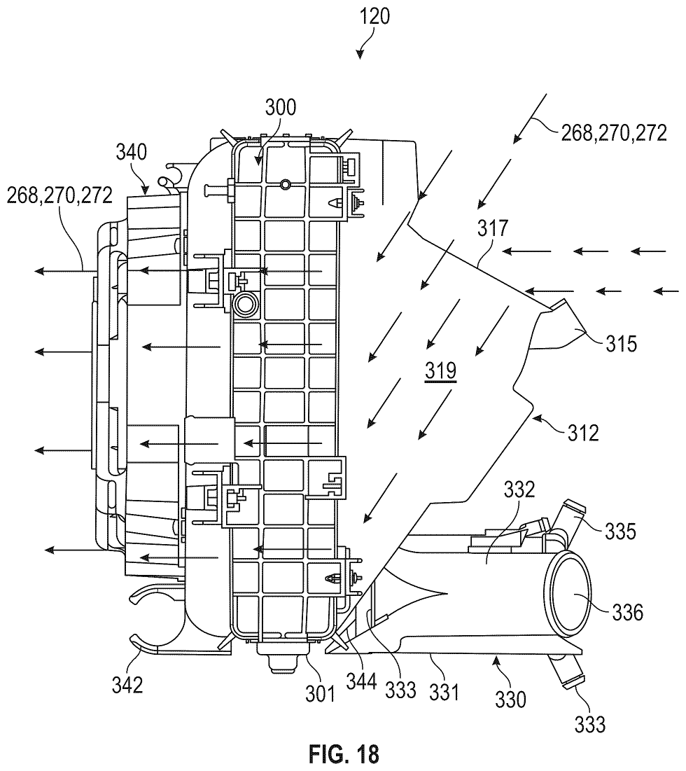

Referring now to FIGS. 17-18, shroud 312 may be operably coupled to a forward side of radiator 300 and a plurality of fasteners may extend through apertures 306 and apertures 320a and a plurality of fasteners may extend through apertures 308 and apertures 322a. Shroud 312 is operably coupled to radiator 300 such that cavity 319 is positioned forwardly of radiator below aperture 317 and air (e.g., air path 268, 270, 272) may flow through grille 326, through aperture 317, into cavity 319 and through radiator 300.

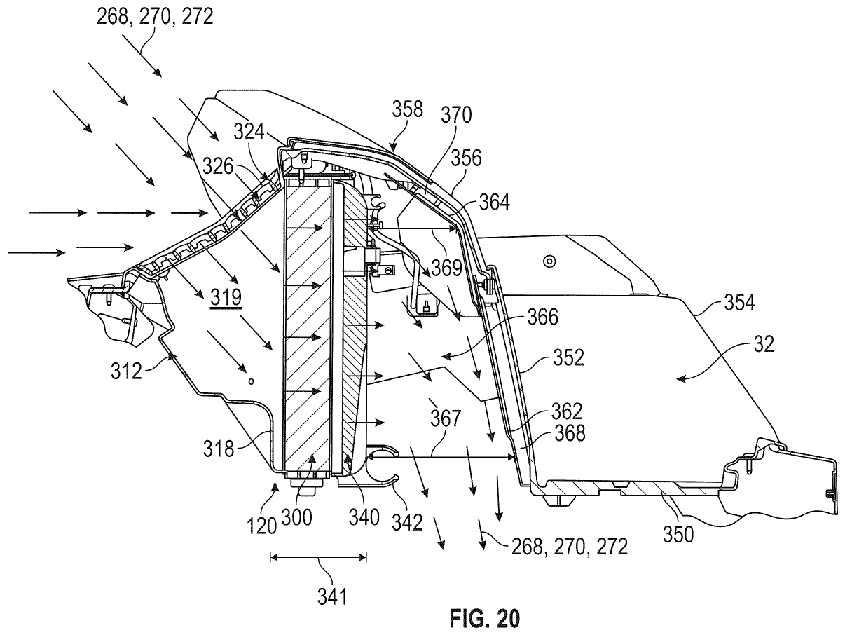

Referring now to FIGS. 20-23, cargo box 32 defines a lower surface or floor 350, a front wall 352, a first side wall or right side wall 354, and a second side wall or left side wall 356. Floor 350 may define one or more corrugations or channels to flow or divert liquid or other debris. A right cover 356 and a left cover 360 are coupled between each of cover 324 and front wall 352 of cargo box 32. In embodiments, right cover 356 and left cover 360 are coupled together. Covers 356, 360 may be positioned vertically above a portion of radiator 300. Covers 356, 360 may be positioned vertically above a portion of fan 340. In embodiments, one or more shields may be coupled to front wall 352 and covers 356, 360. In embodiments, a first shield 362 is coupled to a forward side of front wall 352 and a second shield 364 is coupled to a forward side of covers 356, 360. Further, a first air gap 368 may be created between first shield 362 and front wall 352 and a second air gap 370 may be created between second shield 364 and covers 356, 360. In embodiments, first shield 362 is removably coupled from front wall 352 and second shield 364 is removably coupled to covers 356, 360.

Referring to FIG. 20, a cavity 366 is created between the fan 340 and shields 362, 364. Air may flow along any of air paths 268, 270, 272 through radiator 300 and fan 340, and into cavity 366. Air flowing through cavity 366 may contact one or more of shields 362, 364 and be redirected downwardly to a position below cargo box 32. Shields 362, 364 may thus decrease the extent to which air (e.g., via air paths 268, 270, 272) flows into and along front wall 352 and covers 356, 360.

Referring still to FIG. 20, the radiator 300 and the fan 340 may stand generally upwardly (e.g., transverse to a vehicle centerline L of vehicle 2) and the radiator 300 and the fan 340 may have a combined longitudinal width 341. Further, the cavity 366 has a first width 367 defined at its lower-most extent (e.g., a lower portion of the fan 340 and lower portion of shield 362) and the cavity has a second width 369 defined toward an upper extent (e.g., adjacent an upper portion of the fan 340 and shield 364). In embodiments, the first width 367 is greater than the second width 369. In embodiments, the first width 367 is greater than the width 341. In embodiments, the second width 369 is greater than the width 341.

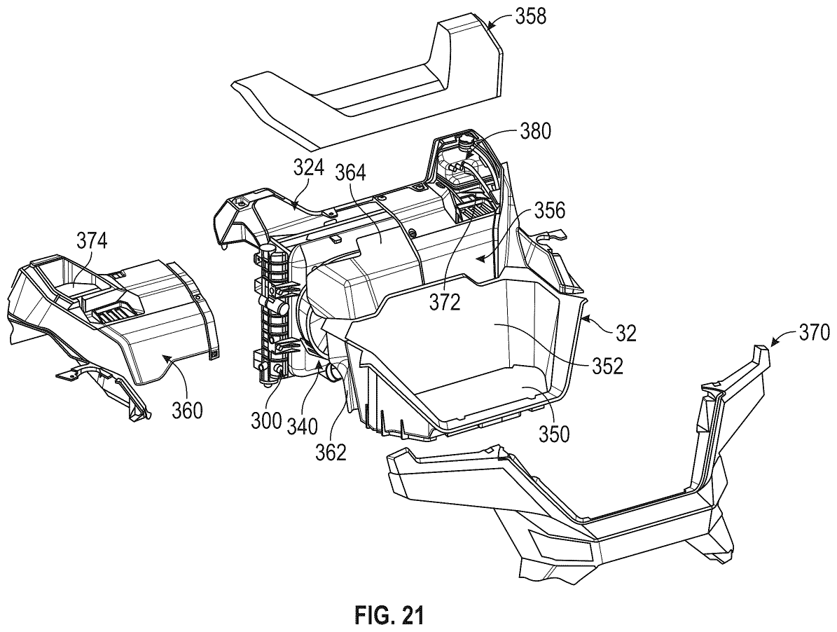

Referring now to FIG. 21, cover 356 defines a recess 372 and a cover 360 defines a recess 374. Illustratively, each of recesses 372, 374 are positioned generally at lateral outward extents of covers 356, 360, respectively. In embodiments, a bottle or reservoir 380 may be positioned within recess 372. In embodiments, bottle or reservoir 380 may be positioned within recess 374. Further, a shield 358 may be removably coupled from covers 356, 360. Shield 358 may provide access to each of covers 356, 360 and recesses 372, 374.

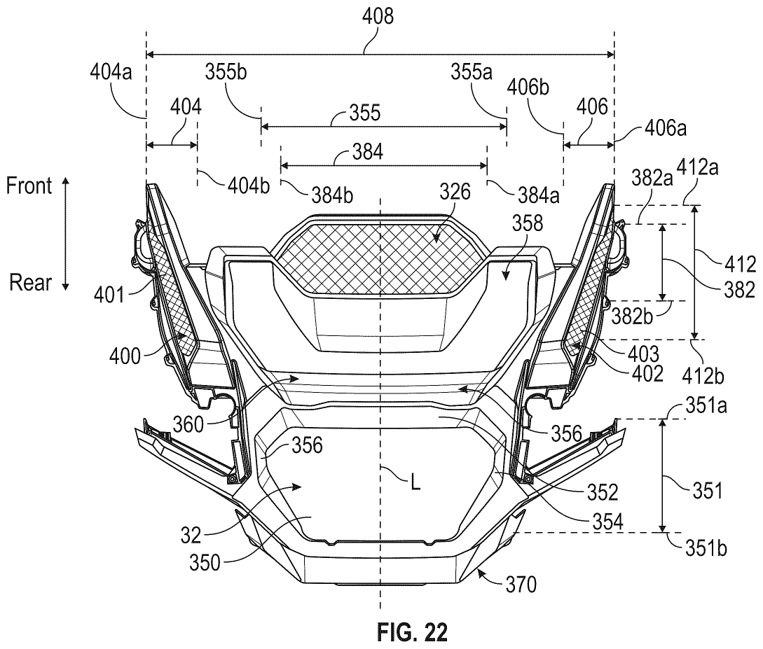

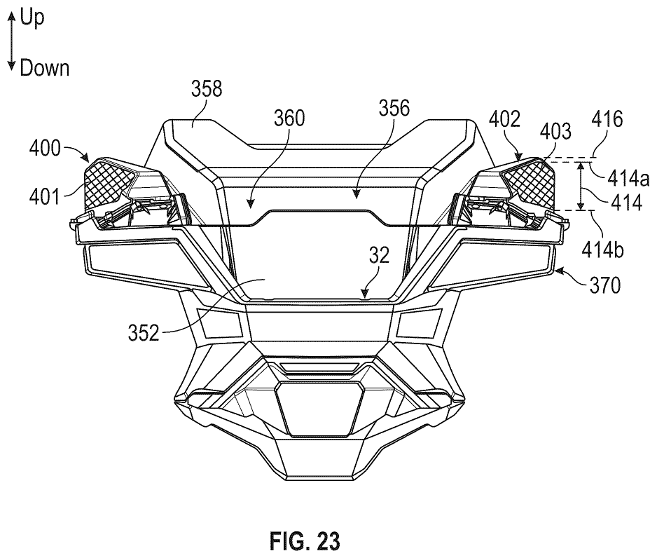

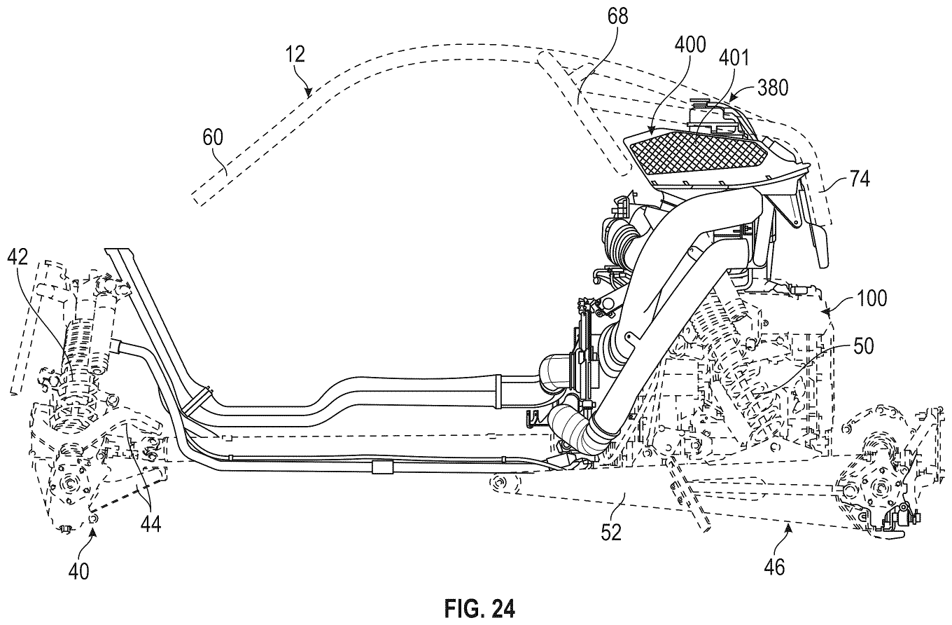

Referring now to FIGS. 22-23, powertrain 100 (FIG. 24) includes a first air inlet housing 400 and a second air inlet housing 402. In embodiments, first air inlet housing 400 includes a first air inlet 401 and second air inlet housing 402 includes a second air inlet 403. In embodiments, air inlet 401 is fluidly coupled to the prime mover 102 and in embodiments, air inlet 403 is fluidly coupled to the CVT 112.

Referring to FIG. 22, grille 326 has a width 384 defined by a first extent or right extent 384a and a second extent or left extent 384b. Further, floor 350 of cargo box 32 has a width 355 defined by a first extent 355a (e.g., right side wall 354) and a second extent 355b (e.g., left side wall 356) and floor 350 of cargo box 32 has a length 351 defined by a forward extent 351a and a rearward extent 351b. First air inlet 401 has a width 404 defined by a first extent or outer extent 404a and a second extent or inner extent 404b. Second air inlet 403 has a width 406 defined by a first extent or outer extent 406a and a second extent or inner extent 406b. Illustratively, the outer extents 404a, 406a are separated by a width 408 and the inner extents 404b, 406b are separated by a width 410. Further, each of air inlets 401, 403 have a length 412 defined by a forward extent 412a and a rearward extent 412b. Further, grille 326 has a length 382 defined by a forward extent 382a and a rearward extent 382b.

Still referring to FIG. 22, right extent 384a and left extent 384b of grille 326 are completely between the outer extents 404a, 406a of air inlets 401, 403, respectively. Further, right extent 384a and left extent 384b of grille 326 are completely between the inner extents 404b, 406b of air inlets 401, 403, respectively. In embodiments, each of right extent 384a and left extent 384b of grille 326 are completely between first extent 355a and second extent 355b of cargo box 32. In embodiments, each of first extent 355a and second extent 355b of cargo box 32 are positioned completely between outer extents 404a, 406a of air inlets 401, 403, respectively. In embodiments, each of first extent 355a and second extent 355b of cargo box 32 are positioned completely between inner extents 404b, 406b of air inlets 401, 403. In embodiments, forward extent 382a of grille 326 is positioned rearwardly of forward extent 412a of inlets 401, 403. In embodiments, rearward extent 382b is positioned forwardly of rearward extent 412b of inlets 401, 403. In embodiments, forward extent 382a and rearward extent 382b are positioned completely between the forward extent 412a and rearward extent 412b of inlets 401, 403.

Referring now to FIG. 23, air inlets 401, 403 have a height 414 defined between an upper extent 414a and a lower extent 414b. Further, grille 326 has an upper extent 416 positioned above the upper extent 414a of air inlets 401, 403.

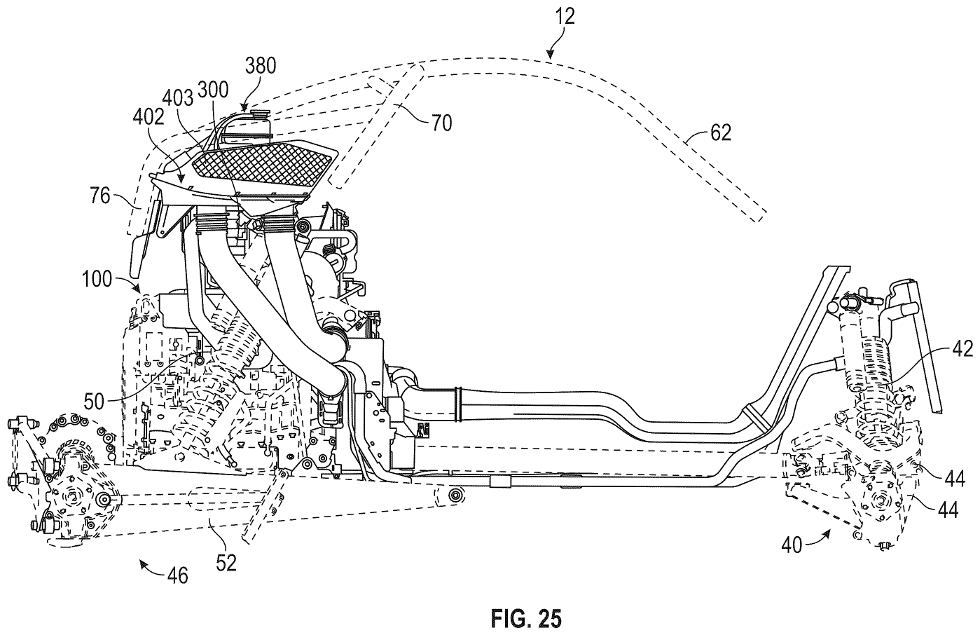

Referring now to FIGS. 24-27, each of first air inlet housing 400 and second air inlet housing 402 are positioned vertically below upper frame assembly 12. In embodiments, first air inlet housing 400 and second air inlet housing 402 are positioned rearwardly of third frame member 68 and fourth frame member 70, respectively.

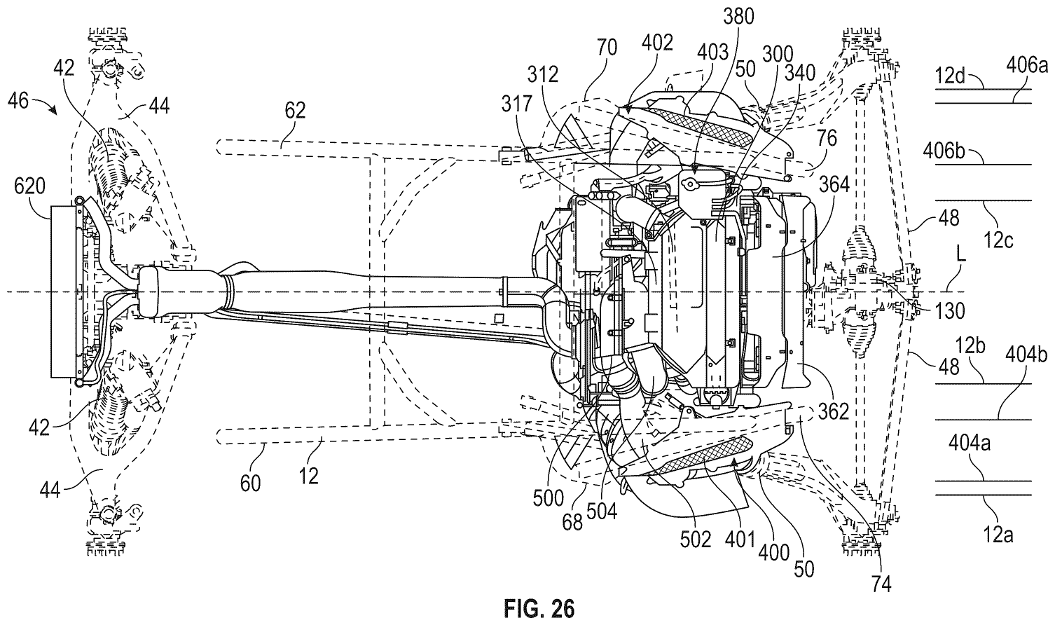

Referring to FIG. 26, radiator 300 is positioned longitudinally aligned with each of first air inlet housing 400 and second air inlet housing 402. In embodiments, each of cover 324, radiator 300, and fan 340 are positioned longitudinally aligned with each of first air inlet housing 400 and second air inlet housing 402. In embodiments, each of first air inlet housing 400 and second air inlet housing 402 are positioned vertically above rear shock absorbers 50. In embodiments, each of first air inlet housing 400 and second air inlet housing 402 are positioned vertically above trailing arms 52.

Referring still to FIG. 26, upper frame assembly 12 generally includes a left side including first frame member, third frame member 68, and fifth frame member 74 and a right side including second frame member 62, fourth frame member 70, and sixth frame member 76. The left side defines a lateral outer extent 12a and a lateral inner extent 12b and the right side defines a lateral outer extent 12d and a lateral inner extent 12c. Further, outer extent 404a of first air inlet 401 is positioned laterally inwardly of lateral outer extent 12a. Further, outer extent 406a of second air inlet 403 is positioned laterally inwardly of lateral outer extent 12d. Further, inner extent 404b is positioned laterally outwardly of lateral inner extent 12b. Further, inner extent 406b is positioned laterally outwardly of lateral inner extent 12c. That is, in the depicted example, the entirety of first air inlet 401 is positioned within a lateral envelope of the left side of upper frame assembly 12 and the entirety of second air inlet 403 is positioned within a lateral envelope of the right side of upper frame assembly 12.

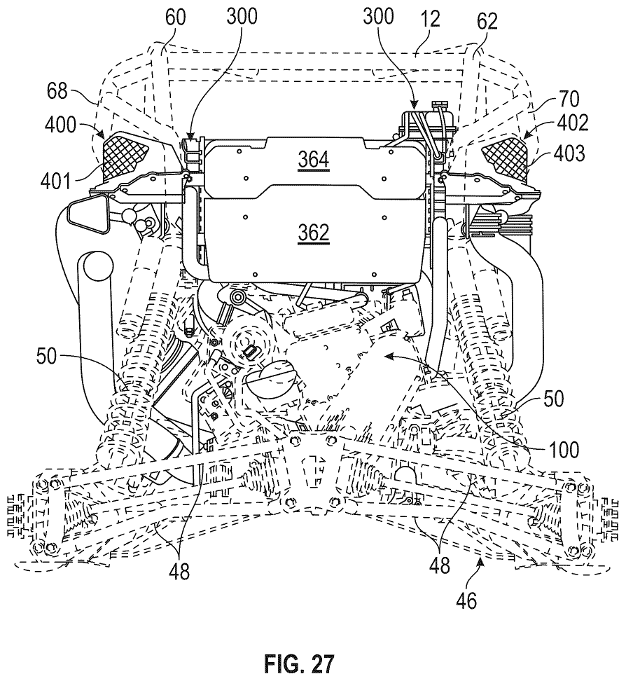

Referring to FIG. 27, each of first air inlet housing 400 and second air inlet housing 402 are at least partially vertically aligned with radiator 300.

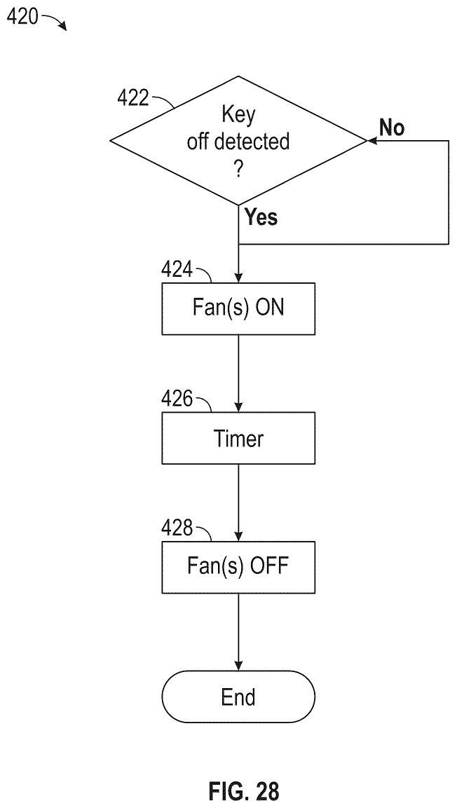

Referring now to FIG. 28, fans 340 of cooling assembly 120 may be operable according to a process 420 which may be implemented by the electronic controller 90 of vehicle 2. Process 420 may start upon the determination that a key-off situation has occurred as shown in block 422. A key-off determination may be made when a user has turned the vehicle to an OFF-state (e.g., power to prime mover limited or eliminated). For example, the user may actuate a key switch or pushbutton of the vehicle. As another example, the user operates an application (e.g., on the user's mobile device) to place the vehicle in the OFF-state. As a further example, the vehicle may be automatically placed in an OFF-state (e.g., after a predetermined time period of inactivity).

After a key-off determination is made, fans 430 may be turned to an ON-state, or may remain in an ON-state if they are already in an ON-state, as indicated in block 424. Fans 430 may operate in according to a duty cycle, according to a full ON-state, or another state or cycle. Fans 430 may operate on a timer for a predetermined amount of time, as indicated by block 426. Fans 430 may operate for 10 seconds, 20 seconds, 30 seconds, 40 seconds, 50 seconds, 60 seconds, or a different amount of time. In examples, the timer is set dynamically (e.g., according to a time period of vehicle operation and/or according to one or more sensed temperatures). After the timer expires in block 426, fans 430 are turned to an OFF-state as indicated in block 428. Process 420 may continue to run fans 430 after vehicle 2 is turned off to continue to pull air through radiator 300 and push air along air paths 268, 270, 272 (FIG. 20) to circulate air below radiator 300 and below cargo box 32. That is, process 420 may enable fans 430 to continue to circulate air through the engine bay surrounding powertrain 100 for a predetermined amount of time after vehicle 2 is turned to an OFF-state to reduce the temperature of powertrain 100 and the surrounding engine bay.

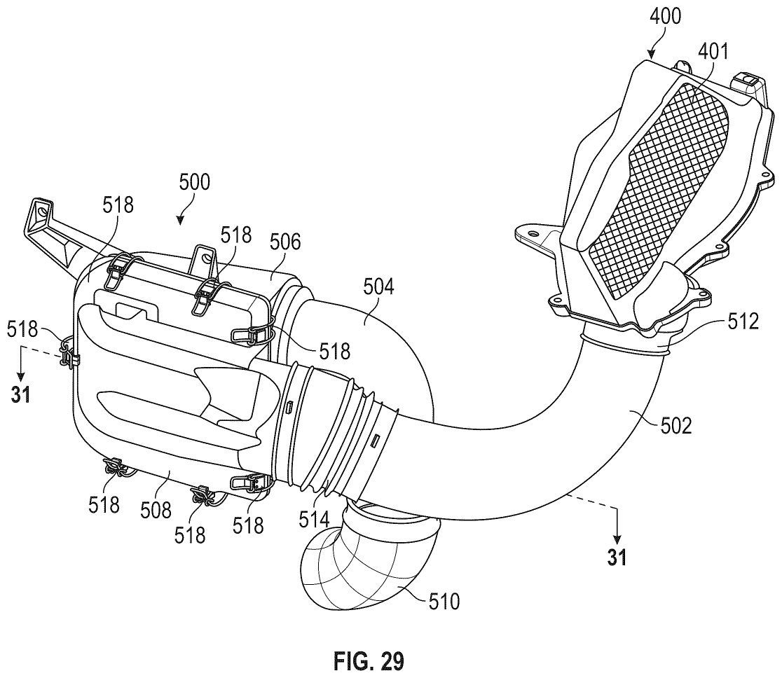

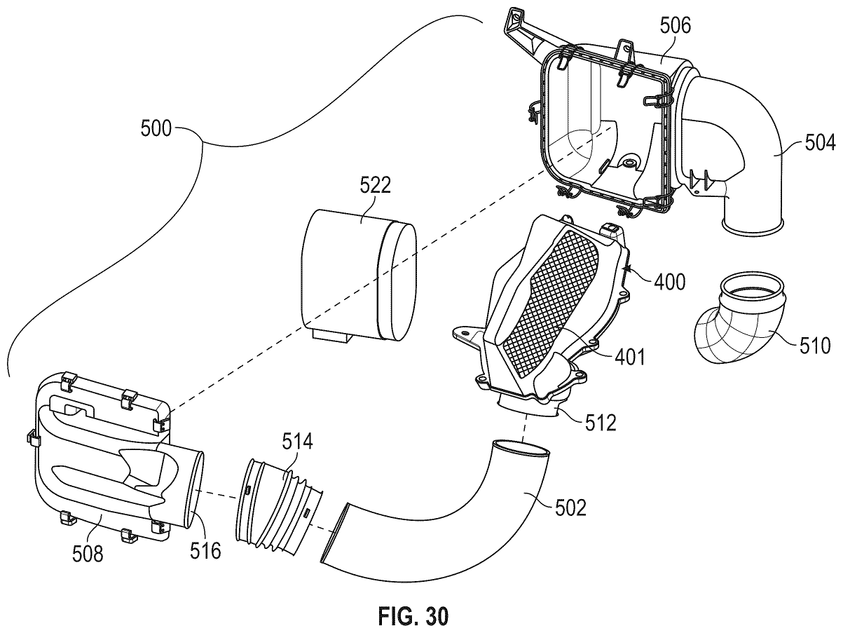

Referring now to FIGS. 29-31, engine intake assembly 102 includes first air inlet housing 400. Engine intake assembly 102 includes an airbox 500, an air inlet 516, a first conduit 502, a second conduit 514, an outlet 504, and a fourth conduit 510. Airbox 500 includes a first housing member 506 and a second housing member 508 defining a cavity 509. First housing member 506 defines the air outlet 504 and second housing member 508 defines the air inlet 516. The first conduit 502 and second conduit 514 are fluidly coupled between the air inlet housing 400 and the airbox 500. That is, first conduit 502 is fluidly coupled to first air inlet housing 400 and second conduit 514 is fluidly coupled between first conduit 502 and air inlet 516. In embodiments, second conduit 514 is a flexible conduit. The third conduit 504 and fourth conduit 510 are coupled between airbox 500 and prime mover 102. That is, third conduit 504 is fluidly coupled to first housing member 506 and fourth conduit 510 is fluidly coupled between third conduit 504 and prime mover 102. In embodiments, a longitudinal centerline axis 501 extends longitudinally along the airbox and air inlet 516 and air outlet 504 are positioned on a first side of the longitudinal centerline axis 501.

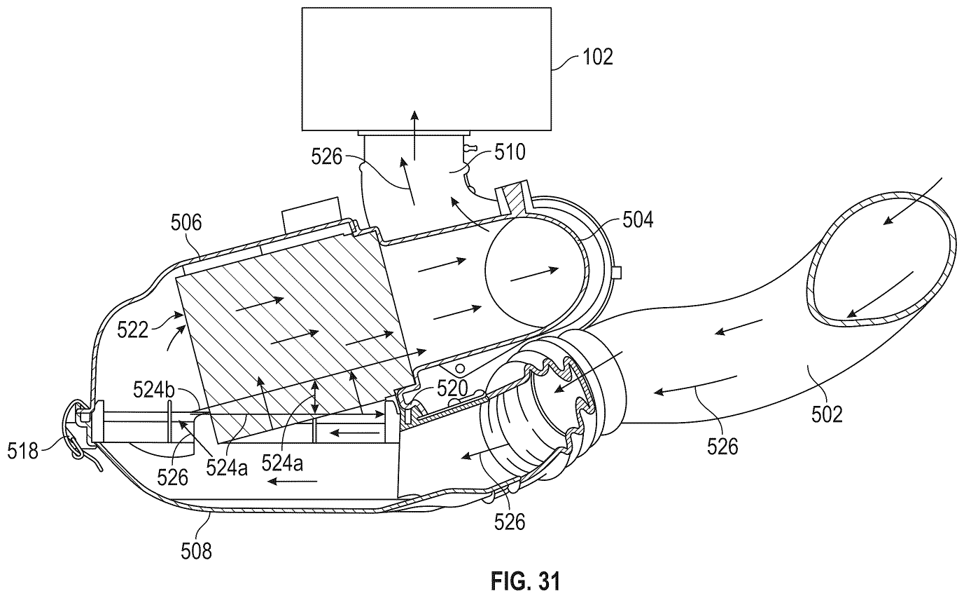

Referring now to FIG. 31, airbox 500 includes a plurality of fasteners or clasps 518 operable to couple first housing member 506 and second housing member 508 together. First housing member 506 and second housing member 508 may couple together by coupling at a hinge 520 and rotating first housing member 506 and second housing member 508 together and fixing clasps 518.

Referring still to FIG. 31, air may flow into housing 500 (e.g., into inlet 516) along a first axis 524a and flow out of housing 500 (e.g., out of outlet 504) along a second axis 524b. First axis 524a is non-parallel to second axis 524b. In embodiments, first axis 524a and second axis 524b define an angle 524. In embodiments, angle 524 is less than 90 degrees. In embodiments, angle 524 is less than 60 degrees. In embodiments, angle 524 is less than 45 degrees. In embodiments, angle 524 is less than 25 degrees.

Referring still to FIG. 31, airbox 500 may include a filter 522 positioned within cavity 509 of first housing member 506 and second housing member 508. Air may pass through filter 522 before flowing into prime mover 102. In embodiments, air flows along an air path 526 through first conduit 502 and through second conduit 514, into inlet 516 and into housing 500. Air flows into housing 500 along axis 524a, flows through filter 522, and out of housing 500 along axis 524b. Air may then flow through outlet 504 and conduit 510 and into prime mover 102.

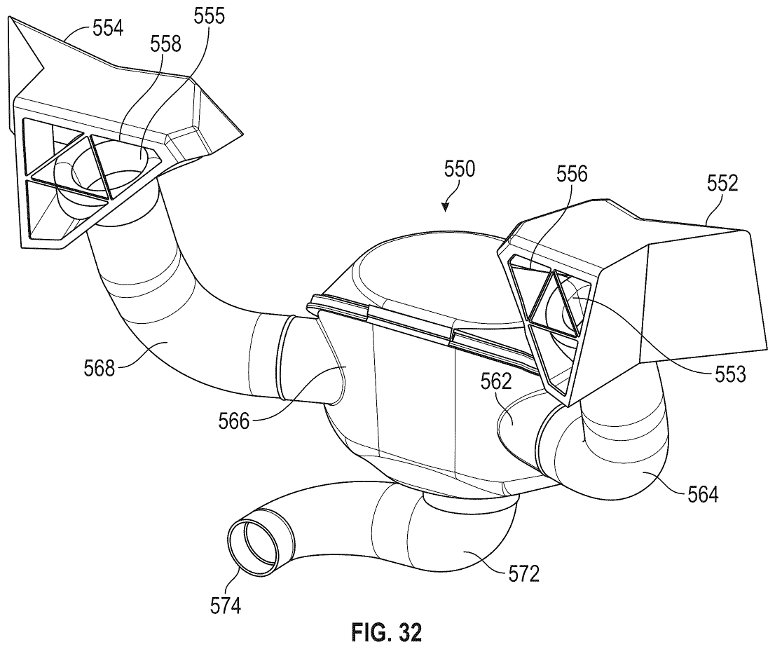

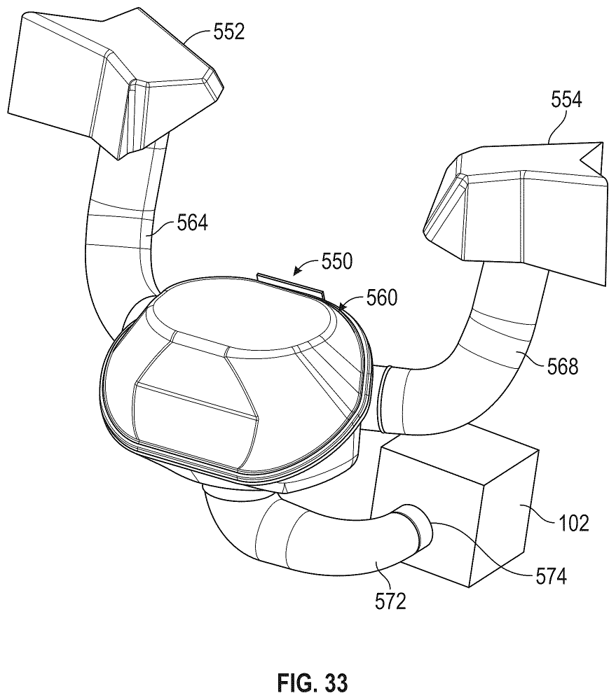

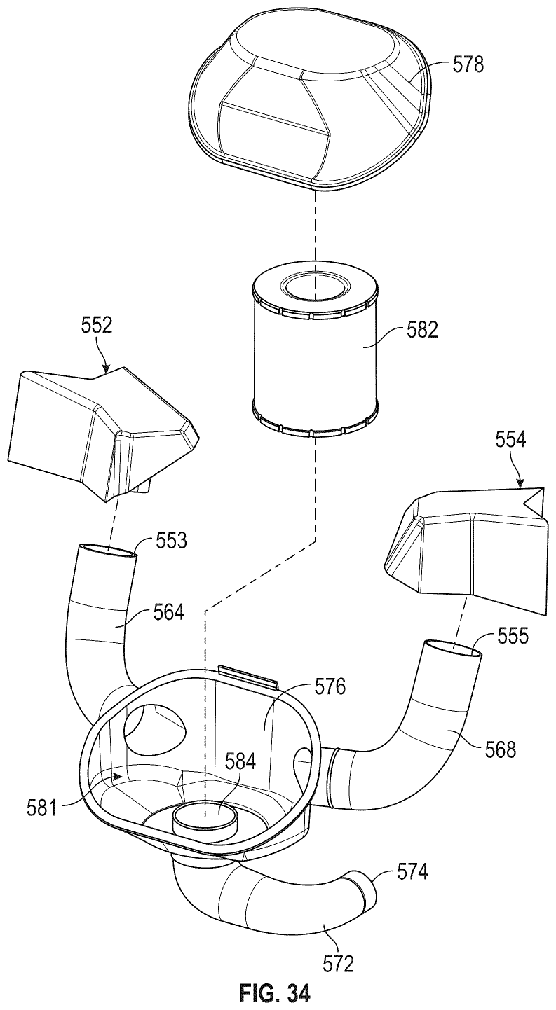

Referring now to FIGS. 32-34, an alternative air intake system 550 may include an alternative airbox 560 that may be utilized with powertrain 100. Air intake system 550 may include a first air inlet housing 552 defining a first air inlet 556 and a second air inlet housing 554 defining a second air inlet 558. Further, housing 552 defines an outlet 553 and housing 554 defines an outlet 555. Airbox 550 includes a first inlet 562, a second inlet 566, and an outlet 570. Air intake system 550 includes a first conduit 564 coupled between outlet 553 of housing 552 and inlet 562 of airbox 560. Further, air intake system 550 includes a second conduit 568 coupled between outlet 555 of housing 554 and inlet 566 of airbox 560. An outlet conduit 572 is coupled to outlet 570 and outlet conduit 572 defines an outlet 574.

Referring still to FIGS. 32-34, airbox 560 includes a first housing portion 576 and a second housing portion 578. First housing portion 576 defines each of the inlets 562, 566 and the outlet 570. The first housing portion 576 includes a tab 580 which may be used to couple with second housing portion 578. Airbox 560 defines a cavity 561 within first housing portion 576 and second housing portion 578. First housing portion 576 defines a flange 584 within cavity 561 and a filter 582 may sit on flange 584 within cavity 561.

Referring still to FIGS. 32-34, air may flow into each of air inlets 556, 558 and through conduits 564, 568, respectively, into airbox 560. Air may flow into cavity 561, through filter 582, and into conduit 572. Air may then flow through outlet 574 and into prime mover 102.

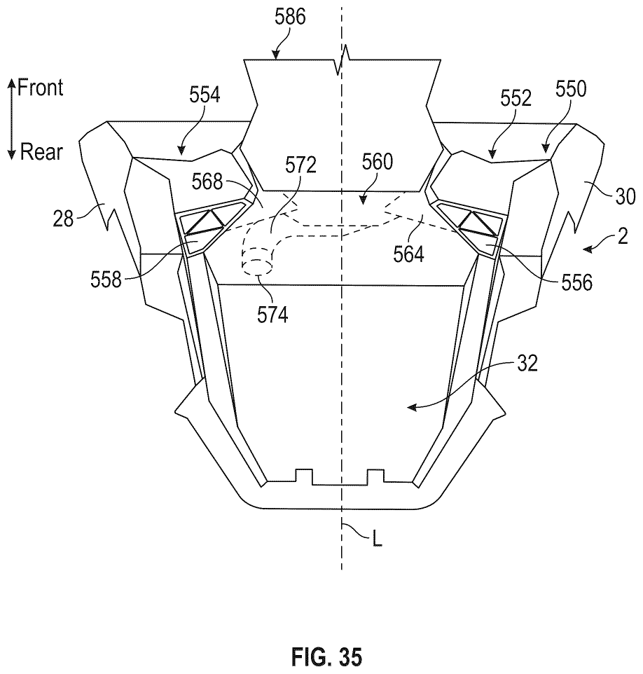

Referring now to FIG. 35, air intake system 550 may be utilized with a vehicle 2′ which may be substantially similar to vehicle 2. In embodiments, each of air inlets 556, 558 may be facing generally rearwardly. Further, each of air inlet housings 552, 554 may be positioned inwardly of rear fenders 28, 30, respectively. Vehicle 2′ may include a shroud 586 which may include access to a cover, shroud, and radiator (e.g., similar to or the same as cover 324, shroud 312, and radiator 300). In embodiments, first air inlet housing 552 may be positioned laterally outwardly from shroud 586 on a first side (e.g., left side) of a vehicle centerline L and second air inlet housing 554 may be positioned laterally outwardly form shroud 586 on a second side (e.g., right side) of vehicle 2′. In embodiments, each of inlets 556, 558 are positioned forwardly of cargo box 32 and inwardly of rear fenders 28, 30.

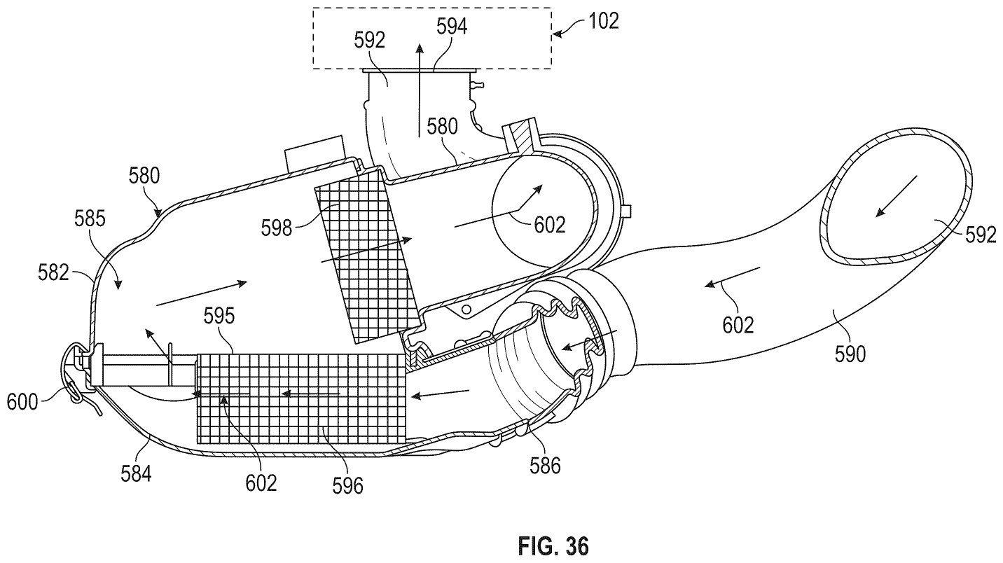

Referring now to FIG. 36, an alternative airbox 580 may be used in place of either airbox 500 or airbox 560 within vehicle 2, 2′. Alternative airbox 580 may include first housing portion 582 and second housing portion 584 coupled together by fasteners 600 (i.e., similar to airbox 500). A cavity 585 is defined between the first housing portion 582 and second housing portion 584. Airbox 580 may include an inlet 586 and a conduit 590 defining an inlet 592 coupled to inlet 586 of airbox 580. Airbox 580 may also include an outlet 588 and a conduit 592 defining an outlet 594 coupled to outlet 588 of airbox 580. Outlet 588 may be fluidly coupled to prime mover 102 to provide air to prime mover 102.

Referring still to FIG. 36, airbox 580 may include a first filter 596 and a second filter 598. In embodiments, housing 580 includes a wall 595 separating the first filter 596 and second filter 598. In embodiments, first filter 596 and second filter 598 may be different filters operable to filter different types of particulates (e.g., size and type of particulate). In embodiments, first filter 596 and second filter 598 may be similar filters operable to filter similar types of particulates.

Referring still to FIG. 36, air may flow along a path 602 through conduit 590, into airbox 580, through first filter 596, through second filter 598, through outlet 588, and into prime mover 102. Airbox 580 includes a dual filter setup which may have more compact packaging due to smaller filters being used, may increase effectiveness of the airbox, or may allow for more complex packaging of the airbox because each smaller filter may be moved and placed in different locations.

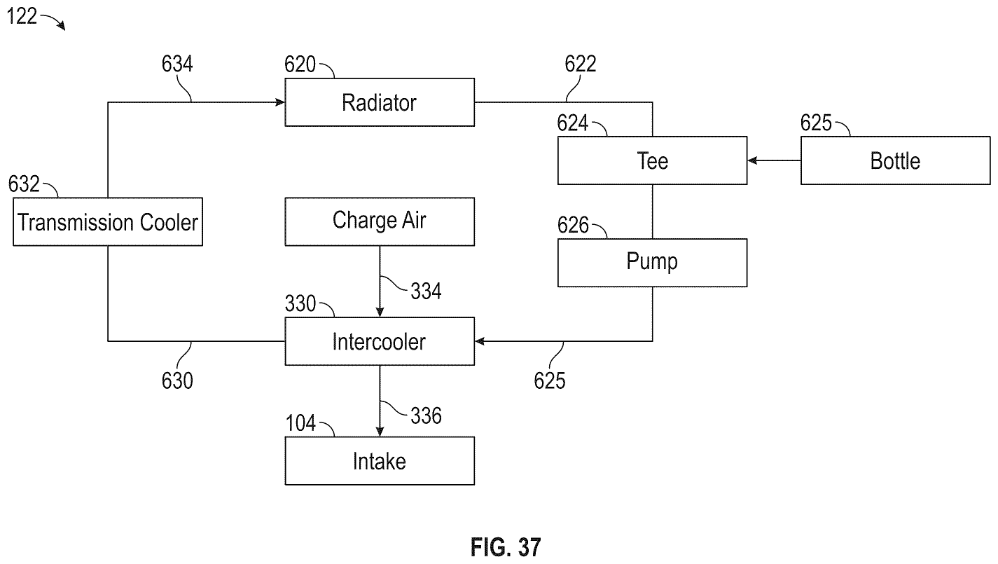

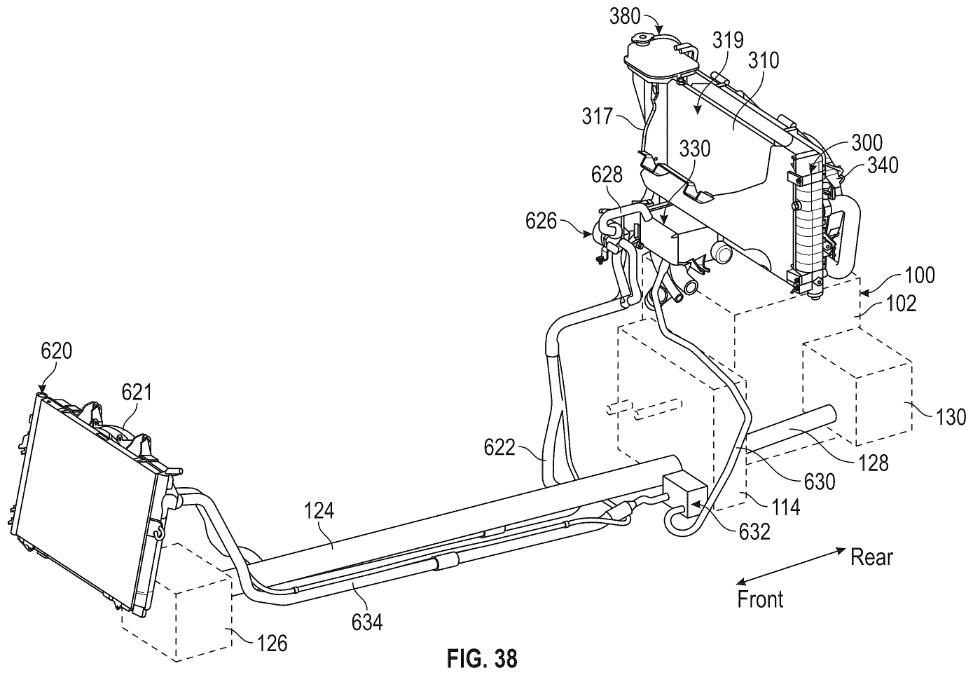

Referring now to FIGS. 37-38, vehicle 2 includes a first driveshaft 124 coupled to shiftable transmission 114 and extending forward to a front drive member 126. Vehicle 2 may also include a second driveshaft 128 coupled to shiftable transmission 114 and extending rearward to a rear drive member 130. In embodiments, front drive member 126 and rear drive member 130 are differentials. Front drive member 126 may be coupled to one or both of front ground engaging members 4 and rear drive member 130 may be coupled to one or both of rear ground engaging members 6.

Still referring to FIGS. 37-38, cooling assembly or cooling circuit 122 includes a radiator 620 positioned at a front of vehicle 2. In embodiments, radiator 620 is positioned generally above and forward of front drive member 126. Cooling assembly 122 includes a pump 626 and a conduit 622 fluidly coupled between the radiator 620 and pump 626. Pump 626 may propel fluid through cooling circuit 122. Cooling circuit 122 includes intercooler 330 and a transmission cooler 632. A conduit 628 may be fluidly coupled between pump 626 and intercooler 330 and a conduit 630 may be fluidly coupled between intercooler 330 and transmission cooler 632. Further, a conduit 634 may be fluidly coupled between transmission cooler 632 and radiator 620. In embodiments, conduits 622, 634 extend longitudinally generally along the driveshaft 124. In embodiments, transmission cooler 632 is coupled to a front side of shiftable transmission 114. In embodiments, each of pump 626 and intercooler 330 are positioned vertically higher than transmission cooler 632. In embodiments, cooling circuit 122 includes a “Tee” junction 624 and may redirect coolant to a reservoir or bottle 625.

Referring still to FIGS. 37-38, transmission cooler 632 may be fluidly coupled to shiftable transmission 114. Transmission cooler 632 may be a liquid to oil cooler such that the coolant within transmission cooler 632 within cooling circuit 122 cools the oil within shiftable transmission 114. The cooling assembly 122 is distinct from the cooling assembly 120, and therefore the transmission cooler 632 coupled to the shiftable transmission 114 may receive lower temperature coolant than if the transmission cooler 632 was a part of the engine cooling circuit (i.e., cooling assembly 120).

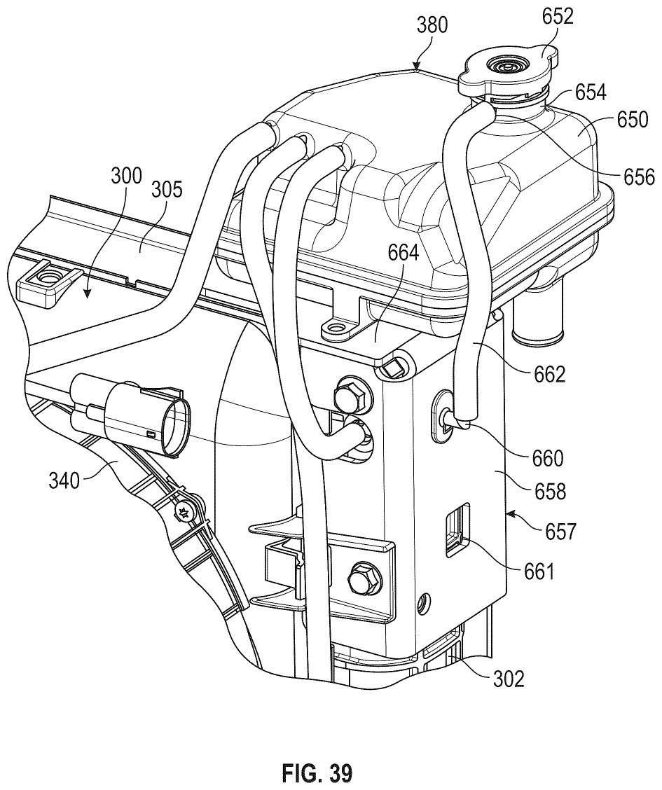

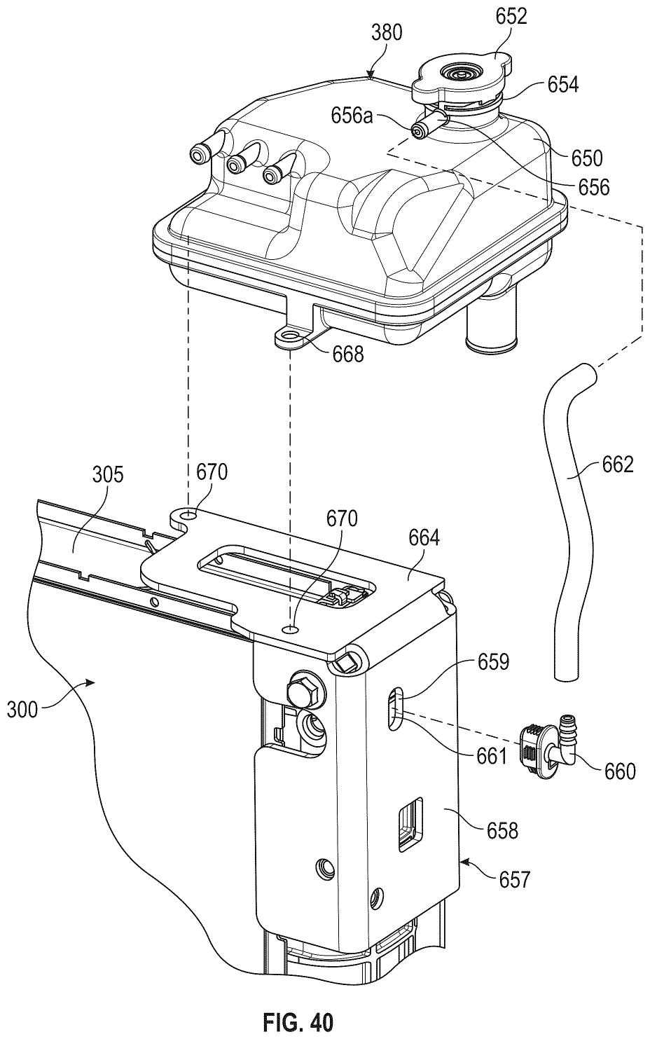

Referring now to FIGS. 39-40, radiator 300 defines a top surface 305, and a bracket 657 may be coupled to each of the right side 302 and top surface 305. Bracket 657 includes a first portion 658 extending alongside right side 302 and a second portion 664 extending along top surface 305. Top surface 305 defines a plurality of apertures 670. Further, first portion 658 defines an aperture 659 and a nozzle 660 sits within aperture 659 and points generally upwardly. Aperture 659 generally provides access to a cavity 661 positioned intermediate the bracket 657 and radiator 300. Bottle 380 includes a neck 654 and a cap 652 positioned on the neck 654. In embodiments, cap 652 is a pressure sensitive cap that changes height in response to pressure within the bottle 380. Bottle 380 defines a body 650 which sits on top of second portion 664 of bracket 657. Body 650 defines at least one aperture 668 and a fastener (not shown) extends between aperture 668 and aperture 670 to couple body 650 to bracket 657. Bottle 380 further includes an extension 656 extending outwardly that defines an aperture 656a which is fluidly coupled to bottle 380. A conduit 662 may be fluidly coupled between extension 656 and nozzle 660 such that conduit 662 is fluidly coupled with cavity 661. As pressure inside bottle 380 increases, cap 652 adjusts and allows fluid access to aperture 656a from bottle 380. That is, as pressure increases within bottle 380, excess coolant may be released from bottle 380, flow through aperture 656a, conduit 662, and into cavity 661. Fluid may drain from cavity 661 downwardly and into a predetermined area underneath radiator 300.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A vehicle, comprising:
a plurality of ground engaging members;
a frame extending along a vehicle centerline and supported by the plurality of ground engaging members;
a powertrain supported by the frame;
a cooling assembly operably coupled to the powertrain, the cooling assembly defining a radiator;
a roof supported by the frame, the roof defining a cavity, an inlet fluidly coupled to the cavity, and an outlet fluidly coupled to the cavity; and
wherein a fluid airpath is defined between the inlet and the outlet, and the roof outlet is operable to direct the fluid airpath toward the radiator.

2. The vehicle of claim 1, wherein the frame surrounds an operator area and the radiator is positioned rearwardly of the operator area.

3. The vehicle of claim 2, wherein the radiator is positioned vertically within an envelope defined by the frame.

4. The vehicle of claim 1, wherein the roof defines a first portion and a second portion, and the first portion is coupled to the second portion, and the cavity is defined between the first portion and the second portion.

5. The vehicle of claim 4, wherein the first portion defines an aperture, and the second portion extends through the aperture.

6. The vehicle of claim 5, further comprising at least one vertically extending support extending between the first portion and the second portion.

7. The vehicle of claim 1, wherein the cooling assembly includes a shroud positioned adjacent the radiator, and the fluid airpath is directed towards the shroud.

8. The vehicle of claim 7, further comprising a cover coupled to the shroud, the cover defining an cover inlet positioned along the vehicle centerline.

9. The vehicle of claim 8, further comprising a cover coupled between the roof and the shroud.

10. The vehicle of claim 8, wherein the powertrain includes an air intake assembly including an air inlet, and the air inlet is positioned longitudinally aligned with the cover inlet.

11. The vehicle of claim 7, wherein the powertrain further comprises a charger and an intercooler fluidly coupled to the charger, the shroud defining a recess and the intercooler positioned within the recess.

12. The vehicle of claim 1, wherein the cooling assembly includes a bracket coupled to the radiator and a coolant bottle coupled to the bracket, the coolant bottle defining a coolant aperture and the bracket defining a bracket aperture, and a conduit coupled between the coolant aperture and the bracket.

13. A roof for a utility vehicle, comprising: a first portion;
a second portion coupled to the first portion, the first portion and the second portion defining an inlet, an outlet spaced from the inlet, and a cavity positioned between the inlet and the outlet, the cavity having a generally consistent cross-sectional area along a longitudinal length of the cavity.

14. The roof of claim 13, wherein the first portion defines an aperture and the second portion extends through the aperture.

15. The roof of claim 13, wherein the first portion defines a rearward extent and a wing portion along the rearward extent, the wing portion extending generally upwardly and rearwardly from the first portion.

16. The roof of claim 13, further comprising at least one vertically extending support coupled between the first portion and the second portion.

17. A cooling assembly for a vehicle including a frame supported by a plurality of ground engaging members, and a powertrain coupled to the plurality of ground engaging members, comprising:
a radiator supported by the frame;
an intercooler longitudinally spaced from the radiator;
a transmission cooler coupled to a transmission of the powertrain; and
a plurality of conduits fluidly coupling the radiator, intercooler, and transmission.

18. The cooling assembly of claim 17, further comprising a pump positioned fluidly intermediate the radiator and the intercooler.

19. The cooling assembly of claim 18, wherein the transmission cooler is longitudinally spaced from the radiator.

20. The cooling assembly of claim 19, wherein the transmission cooler is positioned vertically lower than the intercooler.

21. A vehicle, comprising:
a plurality of ground engaging members;
a frame supported by the plurality of ground engaging members, the frame including a lower frame portion and an upper frame portion, the upper frame portion comprising a first side frame portion and a second side frame portion and at least one cross-member extending between the first side frame portion and the second side frame portion;
a powertrain supported by the frame, the powertrain operably coupled to at least one of the plurality of ground engaging members, the powertrain including an air intake assembly comprising an air inlet; and
wherein the first side frame portion defines a lateral outer extent and a lateral inner extent, and the air inlet is positioned laterally intermediate the lateral outer extent and the lateral inner extent.

22. A method of operating a cooling assembly of a vehicle, the method comprising:
receiving a user input to turn the vehicle to an OFF-state;
operating a fan of the cooling assembly for a predetermined amount of time after the vehicle is altered to the OFF-state; and
wherein the predetermined amount of time is determined based upon one of a calibratable amount of time and a temperature of a powertrain of the vehicle.

23. A powertrain for a vehicle, the powertrain comprising:
a prime mover including an intake inlet and exhaust outlet;
an air intake assembly fluidly coupled to the intake inlet, the air intake assembly comprising an air inlet and an airbox fluidly coupled between the air inlet and the intake inlet, the airbox comprising:
an airbox inlet defining an inlet axis;
an airbox outlet defining an outlet axis; and
an angle defined between the inlet axis and the outlet axis, the angle being less than 90 degrees.

24. The powertrain of claim 23, further comprising a filter positioned within the airbox, the filter positioned fluidly intermediate the airbox inlet and the airbox outlet.

25. The powertrain of claim 23, wherein the airbox comprises a first portion coupled to a second portion, and the first portion defines the airbox inlet and the second portion defines the airbox outlet.

26. The powertrain of claim 23, wherein the angle is less than 45 degrees.

27. The powertrain of claim 23, wherein the air intake assembly includes a housing defining the air inlet, and the housing is positioned above the airbox.

28. The powertrain of claim 27, wherein the airbox defines a longitudinal centerline, and the airbox inlet and the airbox outlet are positioned on a first side of the longitudinal centerline.
